(19) United States
(12) Patent Application Publication
(10) Pub. No.: US 2026/0113478 A1
(43) Pub. Date: Apr. 23, 2026

(54) OVERLAPPED BLOCK MOTION COMPENSATION FOR INTRA TEMPLATE MATCHING PREDICTION (INTRA TMP) AND INTRA BLOCK COPY (IBC)

(71) Applicant: Alibaba (China) Co., Ltd., Hangzhou (CN)

(72) Inventors: Xinwei LI, Beijing (CN); Ru-ling LIAO, Sunnyvale, CA (US); Jie CHEN, Beijing (CN); Yan YE, San Diego, CA (US)

(21) Appl. No.: 19/337,726

(22) Filed: Sep. 23, 2025

Related U.S. Application Data
(60) Provisional application No. 63/709,427, filed on Oct. 19, 2024.

(51) Int. Cl. H04N 19/51; H04N 19/159; H04N 19/176; H04N 19/70

(52) U.S. Cl. CPC H04N 19/51; H04N 19/159; H04N 19/176; H04N 19/70

(57) ABSTRACT

A method of decoding a bitstream includes: receiving a bitstream; and decoding, using coded information of the bitstream, one or more pictures, by: obtaining a first prediction signal based on a first block vector associated with a target subblock on a boundary of a target block of the one or more pictures; obtaining a second prediction signal based on prediction information from a neighboring subblock of the target subblock; and performing a motion compensation, based on the first prediction signal and the second prediction signal, to predict the target subblock.

### CROSS-REFERENCE TO RELATED APPLICATIONS

This application claims priority to U.S. Provisional Application No. 63/709,427, titled “Overlapped Block Motion Compensation for Intra template matching prediction (Intra TMP) and Intra Block Copy (IBC),” filed on Oct. 19, 2024, which is hereby incorporated by reference in its entirety.

### TECHNICAL FIELD

The present disclosure generally relates to video processing, and more particularly, to methods and apparatuses for performing overlapped block motion compensation for Intra Template Matching (Intra TMP) and Intra Block Copy (IBC).

### BACKGROUND

A video is a set of static pictures (or “frames”) capturing the visual information. To reduce the storage memory and the transmission bandwidth, a video can be compressed before storage or transmission and decompressed before display. The compression process is usually referred to as encoding and the decompression process is usually referred to as decoding. There are various video coding formats which use standardized video coding technologies, most commonly based on prediction, transformation, quantization, entropy coding and in-loop filtering. The video coding standards, such as the High Efficiency Video Coding (HEVC/H.265) standard, the Versatile Video Coding (VVC/H.266) standard, AVS standards, specifying the specific video coding formats, are developed by standardization organizations. With more and more advanced video coding technologies being adopted in the video standards, the coding efficiency of the new video coding standards get higher and higher.

### SUMMARY

Embodiments of the present disclosure provide methods and apparatuses for performing overlapped block motion compensation for Intra Template Matching (Intra TMP) and Intra Block Copy (IBC).

In some embodiments, a method for decoding a bitstream associated with a video sequence is provided. The method includes: receiving a bitstream and decoding, using coded information of the bitstream, one or more pictures, by: obtaining a first prediction signal based on a first block vector associated with a target subblock on a boundary of a target block of the one or more pictures; obtaining a second prediction signal based on prediction information from a neighboring subblock of the target subblock; and performing a motion compensation, based on the first prediction signal and the second prediction signal, to predict the target subblock.

In some embodiments, a method for encoding a video sequence into a bitstream is provided. The method includes: receiving a video sequence, and encoding one or more pictures of the video sequence to generate a bitstream. The encoding comprises: obtaining a first prediction signal based on a first block vector associated with a target subblock on a boundary of a target block of the one or more pictures; obtaining a second prediction signal based on prediction information from a neighboring subblock of the target subblock; and performing a motion compensation, based on the first prediction signal and the second prediction signal, to predict the target subblock.

In some embodiments, a method for transmitting a bitstream is provided. The method includes: receiving a video sequence including one or more pictures, encoding the video sequence, and signaling a bitstream generated based on the encoding. The video sequence is encoded by: obtaining a first prediction signal based on a first block vector associated with a target subblock on a boundary of a target block of the one or more pictures, obtaining a second prediction signal based on prediction information from a neighboring subblock of the target subblock, and performing a motion compensation, based on the first prediction signal and the second prediction signal, to predict the target subblock.

### BRIEF DESCRIPTION OF THE DRAWINGS

Embodiments and various aspects of the present disclosure are illustrated in the following detailed description and the accompanying figures. Various features shown in the figures are not drawn to scale.

FIG. 1 illustrates structures of an example video sequence, according to some embodiments of the present disclosure.

FIG. 2 illustrates a schematic diagram of an example encoder of a video coding system, according to some embodiments of the present disclosure.

FIG. 3 illustrates a schematic diagram of an example decoder of a video coding system, according to some embodiments of the present disclosure.

FIG. 4 is a block diagram of an example apparatus for encoding or decoding a video, according to some embodiments of the present disclosure.

FIG. 5 is a schematic diagram illustrating top and left coding unit (CU) boundaries of Overlapped Block Motion Compensation (OBMC), according to some embodiments of the present disclosure.

FIG. 6 is a schematic diagram illustrating a template matching-based OBMC scheme, according to some embodiments of the present disclosure.

FIGS. 7A-7D are schematic diagrams illustrating reference regions of an Intra Block Copy (IBC) mode, according to some embodiments of the present disclosure.

FIG. 8A is a schematic diagram illustrating block vector (BV) adjustment for horizontal flip, according to some embodiments of the present disclosure.

FIG. 8B is a schematic diagram illustrating BV adjustment for vertical flip, according to some embodiments of the present disclosure.

FIG. 9 is a schematic diagram illustrating sub-pel positions used for an Intra Template Matching Prediction (Intra TMP) sub-pel mode, according to some embodiments of the present disclosure.

FIG. 10 is a schematic diagram illustrating exemplary reference samples used in a planar mode, according to some embodiments of the present disclosure.

FIG. 11 is a schematic diagram illustrating angular intra prediction modes used for video coding, according to some embodiments of the present disclosure.

FIG. 12 is a schematic diagram illustrating a multiple reference line (MRL) intra prediction mode, according to some embodiments of the present disclosure.

FIG. 13 is a schematic diagram illustrating extended MRL candidate list used in an MRL intra prediction mode, according to some embodiments of the present disclosure.

FIG. 14A is a schematic diagram illustrating an example of intra sub-partitions (ISP) depending on the block size, according to some embodiments of the present disclosure.

FIG. 14B is a schematic diagram illustrating an example of ISP depending on the block size, according to some embodiments of the present disclosure.

FIG. 15 is a schematic diagram illustrating an example matrix weighted intra prediction process, according to some embodiments of the present disclosure.

FIG. 16 is a schematic diagram illustrating example samples used for calculating gradients in a decoder side intra mode derivation (DIMD) mode, according to some embodiments of the present disclosure.

FIG. 17 is a schematic diagram illustrating L shaped neighborhood for a given predicted block, according to some embodiments of the present disclosure.

FIG. 18 is a schematic diagram illustrating spatial parts of a convolutional filter, according to some embodiments of the present disclosure.

FIG. 19 is a schematic diagram illustrating a corresponding luma block for a direct mode (DM) mode in an I Slice, according to some embodiments of the present disclosure.

FIGS. 20A-C are schematic diagrams illustrating neighboring reconstructed samples used for a DIMD chroma mode, according to some embodiments of the present disclosure.

FIG. 21 is a schematic diagram illustrating luma blocks used to derive direct block vectors, according to some embodiments of the present disclosure.

FIG. 22 is a schematic diagram illustrating block vectors and prediction signals of a sub-block in a top boundary of a CU when intra OBMC is performed, according to some embodiments of the present disclosure.

FIG. 23 is a schematic diagram illustrating merged sub-blocks when intra OBMC is performed, according to some embodiments of the present disclosure.

FIG. 24 is a schematic diagram illustrating padding a block vector of a neighboring sub-block, according to some embodiments of the present disclosure.

FIG. 25A is a schematic diagram illustrating samples used for deriving an intra prediction mode in a 4×4 sub-block, according to some embodiments of the present disclosure.

FIG. 25B is a schematic diagram illustrating samples used for deriving an intra prediction mode in a 4×4 sub-block, according to some embodiments of the present disclosure.

FIG. 26 is a schematic diagram illustrating samples used for deriving an intra prediction mode in a 4×4 sub-block, according to some embodiments of the present disclosure.

FIG. 27 is a schematic diagram illustrating samples used for deriving an intra prediction mode in a merged block, according to some embodiments of the present disclosure.

FIG. 28 is a flowchart of an example method of decoding a bitstream, according to some embodiments of the present disclosure.

FIG. 29 is a flowchart for an example method of encoding a video sequence into a bitstream, according to some embodiments of the present disclosure.

### DETAILED DESCRIPTION

Reference will now be made in detail to embodiments, examples of which are illustrated in the accompanying drawings. The following description refers to the accompanying drawings in which the same numbers in different drawings represent the same or similar elements unless otherwise represented. The implementations set forth in the following description of embodiments do not represent all implementations consistent with the disclosure. Instead, they are merely examples of apparatuses and methods consistent with aspects related to the disclosure as recited in the appended claims. Particular aspects of the present disclosure are described in greater detail below. The terms and definitions provided herein control, if in conflict with terms and/or definitions incorporated by reference.

The Joint Video Experts Team (JVET) of the ITU-T Video Coding Expert Group (ITU-T VCEG) and the ISO/IEC Moving Picture Expert Group (ISO/IEC MPEG) is currently developing the Versatile Video Coding (VVC/H.266) standard. The VVC standard is aimed at doubling the compression efficiency of its predecessor, the High Efficiency Video Coding (HEVC/H.265) standard. In other words, VVC's goal is to achieve the same subjective quality as HEVC/H.265 using half the bandwidth.

To achieve this goal, since 2015, the JVET has been developing technologies beyond HEVC using the joint exploration model (JEM) reference software. As coding technologies being incorporated into the JEM, the JEM achieved substantially higher coding performance than HEVC. In October 2017, a joint call for proposals (CfP) was issued by VCEG and MPEG to formally start the development of next generation video compression standard beyond HEVC. Responses to the CfP were evaluated at the JVET meeting in San Diego in April 2018, and the formal development process of the VVC standard started in April 2018.

The VVC standard has been progressing well since April 2018, and continues to include more coding technologies that provide better compression performance. VVC is based on the same hybrid video coding system that has been used in modern video compression standards such as HEVC, H.264/AVC, MPEG2, H.263, etc. In July 2020, the first version of VVC standard is finalized and is published as an international standard. Afterward, the JVET starts exploring new coding tools to further improve the coding performance of the VVC standard. In January 2021, the Enhanced Compression Model (ECM) has been proposed and used as new software base for developing tools beyond the VVC standard.

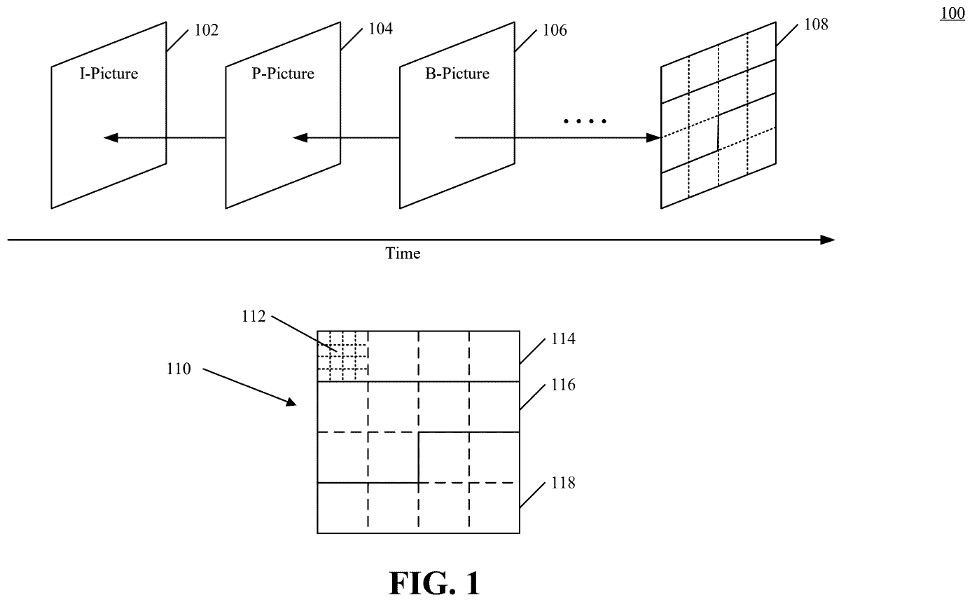

FIG. 1 illustrates structures of an example video sequence, according to some embodiments of the present disclosure. Video sequence 100 can be a live video or a video having been captured and archived. Video sequence 100 can be a real-life video, a computer-generated video (e.g., computer game video), or a combination thereof (e.g., a real-life video with augmented-reality effects). Video sequence 100 can be inputted from a video capture device (e.g., a camera), a video archive (e.g., a video file stored in a storage device) containing previously captured video, or a video feed interface (e.g., a video broadcast transceiver) to receive video from a video content provider. As shown in FIG. 1, video sequence 100 can include a series of pictures arranged temporally along a timeline, including pictures 102, 104, 106, and 108. Pictures 102-106 are continuous, and there are more pictures between pictures 106 and 108.

When a video is being compressed or decompressed, useful information of a picture being encoded (referred to as a “current picture”) include changes with respect to a reference picture (e.g., a picture previously encoded and reconstructed). Such changes can include position changes, luminosity changes, or color changes of the pixels. For example, position changes of a group of pixels can reflect the motion of an object represented by these pixels between two pictures (e.g., the reference picture and the current picture).

For example, as shown in FIG. 1, picture 102 is an I-picture, using itself as the reference picture. Picture 104 is a P-picture, using picture 102 as its reference picture, as indicated by the arrow. Picture 106 is a B-picture, using pictures 104 and 108 as its reference pictures, as indicated by the arrows. In some embodiments, the reference picture of a picture may be or may not be immediately preceding or following the picture. For example, the reference picture of picture 104 can be a picture preceding picture 102, i.e., a picture not immediately preceding picture 104. The above-described reference pictures of pictures 102-106 shown in FIG. 1 are merely examples and not meant to limit the present disclosure.

Due to the computing complexity, in some embodiments, video codecs can split a picture into multiple basic segments and encode or decode the picture segment by segment. That is, video codecs do not necessarily encode or decode an entire picture at one time. Such basic segments are referred to as basic processing units (“BPUs”) in the present disclosure. For example, FIG. 1 also shows an example structure 110 of a picture of video sequence 100 (e.g., any of pictures 102-108). For example, structure 110 may be used to divide picture 108. As shown in FIG. 1, picture 108 is divided into 4×4 basic processing units. In some embodiments, the basic processing units can be referred to as “coding tree units” (“CTUs”) in some video coding standards (e.g., AVS3, H.265/HEVC or H.266/VVC), or as “macroblocks” in some video coding standards (e.g., MPEG family, H.261, H.263, or H.264/AVC). In AVS3 or VVC, a coded tree unit (CTU) can be the largest block unit and can be as large as 128×128 luma samples (plus the corresponding chroma samples depending on the chroma format).

The basic processing units in FIG. 1 are for illustrative purpose only. The basic processing units can have variable sizes in a picture, such as 128×128, 64×64, 32×32, 16×16, 4×8, 16×32, or any arbitrary shape and size of pixels. The sizes and shapes of the basic processing units can be selected for a picture based on the balance of coding efficiency and levels of details to be kept in the basic processing unit.

The basic processing units can be logical units, which can include a group of different types of video data stored in a computer memory (e.g., in a video frame buffer). For example, a basic processing unit of a color picture can include a luma component (Y) representing achromatic brightness information, one or more chroma components (e.g., Cb and Cr) representing color information, and associated syntax elements, in which the luma and chroma components can have the same size of the basic processing unit. The luma and chroma components can be referred to as “coding tree blocks” (“CTBs”) in some video coding standards. Operations performed to a basic processing unit can be repeatedly performed to its luma and chroma components.

During multiple stages of operations in video coding, the size of the basic processing units may still be too large for processing, and thus can be further partitioned into segments referred to as “basic processing sub-units” in the present disclosure. For example, at a mode decision stage, the encoder can split the basic processing unit into multiple basic processing sub-units and decide a prediction type for each individual basic processing sub-unit. As shown in FIG. 1, basic processing unit 112 in structure 110 is further partitioned into 4×4 basic processing sub-units. For example, a coded tree unit CTU may be further partitioned into coding units (CUs) using quad-tree, binary tree, or extended binary tree. The basic processing sub-units in FIG. 1 is for illustrative purpose only. Different basic processing units of the same picture can be partitioned into basic processing sub-units in different schemes. The basic processing sub-units can be referred to as “coding units” (“CUs”) in some video coding standards (e.g., AVS3, H.265/HEVC or H.266/VVC), or as “blocks” in some video coding standards (e.g., MPEG family, H.261, H.263, or H.264/AVC). The size of a basic processing sub-unit can be the same or smaller than the size of a basic processing unit. Similar to the basic processing units, basic processing sub-units are also logical units, which can include a group of different types of video data (e.g., Y, Cb, Cr, and associated syntax elements) stored in a computer memory (e.g., in a video frame buffer). Operations performed to a basic processing sub-unit can be repeatedly performed to its luma and chroma components. Such division can be performed to further levels depending on processing needs, and in different stages, the basic processing units can be partitioned using different schemes. At the leaf nodes of the partitioning structure, coding information such as coding mode (e.g., intra prediction mode or inter prediction mode), motion information (e.g., reference index, motion vectors (MVs), etc.) required for corresponding coding mode, and quantized residual coefficients are sent.

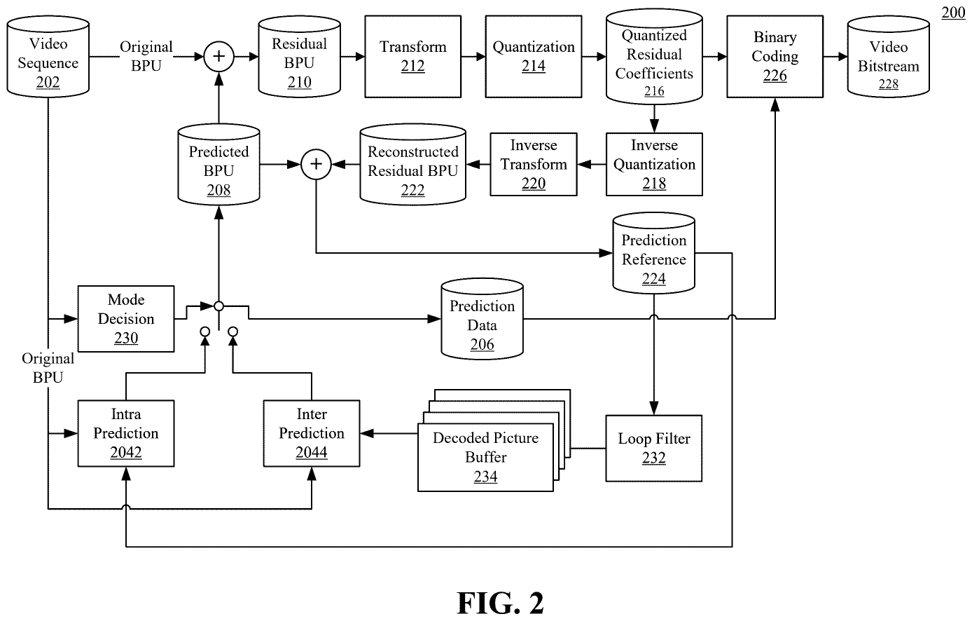

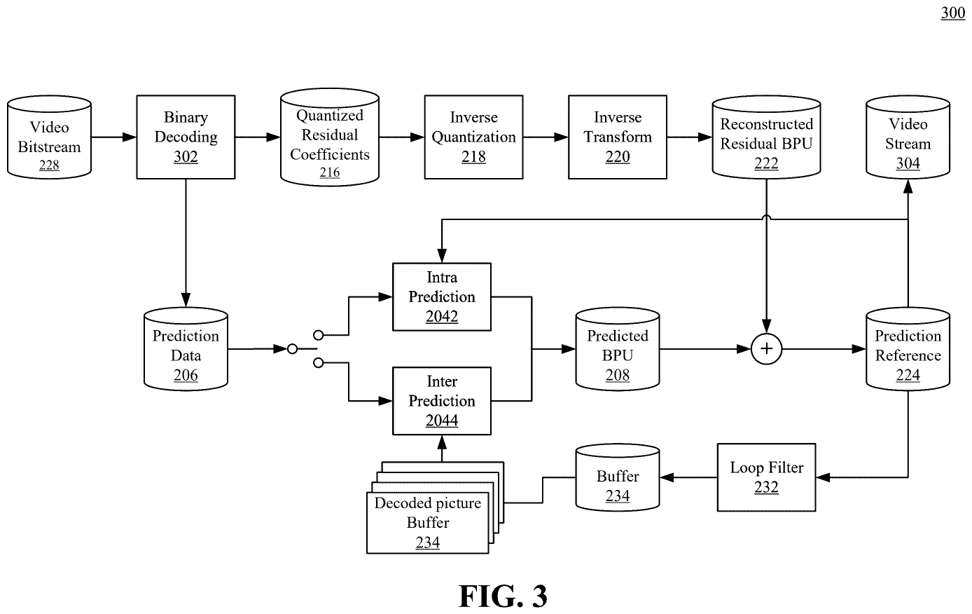

In some cases, a basic processing sub-unit can still be too large to process in some stages of operations in video coding, such as a prediction stage or a transform stage. Accordingly, the encoder can further split the basic processing sub-unit into smaller segments (e.g., referred to as “prediction blocks” or “PBs”), at the level of which a prediction operation can be performed. Similarly, the encoder can further split the basic processing sub-unit into smaller segments (e.g., referred to as “transform blocks” or “TBs”), at the level of which a transform operation can be performed. The division schemes of the same basic processing sub-unit can be different at the prediction stage and the transform stage. For example, the prediction blocks (PBs) and transform blocks (TBs) of the same CU can have different sizes and numbers. Operations in the mode decision stage, the prediction stage, the transform stage will be detailed in later paragraphs with examples provided in FIG. 2 and FIG. 3.

FIG. 2 illustrates a schematic diagram of an example encoder 200 of a video coding system, (e.g., AVS3 or H.26x series), according to some embodiments of the present disclosure. The input video is processed block by block. As discussed above, in some coding standards, a coded tree unit (CTU) is the largest block unit and can be as large as 128×128 luma samples (plus the corresponding chroma samples depending on the chroma format). One CTU may be further partitioned into CUs using quad-tree, binary tree, or ternary tree. Referring to FIG. 2, encoder 200 can receive video sequence 202 generated by a video capturing device (e.g., a camera). The term “receive” used herein can refer to receiving, inputting, acquiring, retrieving, obtaining, reading, accessing, or any action in any manner for inputting data. Encoder 200 can encode video sequence 202 into video bitstream 228. Similar to video sequence 100 in FIG. 1, video sequence 202 can include a set of pictures (referred to as “original pictures”) arranged in a temporal order. Similar to structure 110 in FIG. 1, any original picture of video sequence 202 can be divided by encoder 200 into basic processing units, basic processing sub-units, or regions for processing. In some embodiments, encoder 200 can perform process at the level of basic processing units for original pictures of video sequence 202. For example, encoder 200 can perform process in FIG. 2 in an iterative manner, in which encoder 200 can encode a basic processing unit in one iteration of process. In some embodiments, encoder 200 can perform process in parallel for regions (e.g., slices 114-118 in FIG. 1) of original pictures of video sequence 202.

Components 202, 2042, 2044, 206, 208, 210, 212, 214, 216, 226, and 228 can be referred to as a “forward path.” In FIG. 2, encoder 200 can feed a basic processing unit (referred to as an “original BPU”) of an original picture of video sequence 202 to two prediction stages, intra prediction (also known as an “intra-picture prediction” or “spatial prediction”) stage 2042 and inter prediction (also known as an “inter-picture prediction,” “motion compensation,” “motion compensated prediction” or “temporal prediction”) stage 2044 to perform a prediction operation and generate corresponding prediction data 206 and predicted BPU 208. Particularly, encoder 200 can receive the original BPU and prediction reference 224, which can be generated from the reconstruction path of the previous iteration of process.

The purpose of intra prediction stage 2042 and inter prediction stage 2044 is to reduce information redundancy by extracting prediction data 206 that can be used to reconstruct the original BPU as predicted BPU 208 from prediction data 206 and prediction reference 224. In some embodiments, an intra prediction can use pixels from one or more already coded neighboring BPUs in the same picture to predict the current BPU. That is, prediction reference 224 in the intra prediction can include the neighboring BPUs, so that spatial neighboring samples can be used to predict the current block. The intra prediction can reduce the inherent spatial redundancy of the picture.

In some embodiments, an inter prediction can use regions from one or more already coded pictures (“reference pictures”) to predict the current BPU. That is, prediction reference 224 in the inter prediction can include the coded pictures. The inter prediction can reduce the inherent temporal redundancy of the pictures.

In the forward path, encoder 200 performs the prediction operation at intra prediction stage 2042 and inter prediction stage 2044. For example, at intra prediction stage 2042, encoder 200 can perform the intra prediction. For an original BPU of a picture being encoded, prediction reference 224 can include one or more neighboring BPUs that have been encoded (in the forward path) and reconstructed (in the reconstructed path) in the same picture. Encoder 200 can generate predicted BPU 208 by extrapolating the neighboring BPUs. The extrapolation technique can include, for example, a linear extrapolation or interpolation, a polynomial extrapolation or interpolation, or the like. In some embodiments, encoder 200 can perform the extrapolation at the pixel level, such as by extrapolating values of corresponding pixels for each pixel of predicted BPU 208. The neighboring BPUs used for extrapolation can be located with respect to the original BPU from various directions, such as in a vertical direction (e.g., on top of the original BPU), a horizontal direction (e.g., to the left of the original BPU), a diagonal direction (e.g., to the down-left, down-right, up-left, or up-right of the original BPU), or any direction defined in the used video coding standard. For the intra prediction, prediction data 206 can include, for example, locations (e.g., coordinates) of the used neighboring BPUs, sizes of the used neighboring BPUs, parameters of the extrapolation, a direction of the used neighboring BPUs with respect to the original BPU, or the like.

For another example, at inter prediction stage 2042, encoder 200 can perform the inter prediction. For an original BPU of a current picture, prediction reference 224 can include one or more pictures (referred to as “reference pictures”) that have been encoded (in the forward path) and reconstructed (in the reconstructed path). In some embodiments, a reference picture can be encoded and reconstructed BPU by BPU. For example, encoder 200 can add reconstructed residual BPU 222 to predicted BPU 208 to generate a reconstructed BPU. When all reconstructed BPUs of the same picture are generated, encoder 200 can generate a reconstructed picture as a reference picture. Encoder 200 can perform an operation of “motion estimation” to search for a matching region in a scope (referred to as a “search window”) of the reference picture. The location of the search window in the reference picture can be determined based on the location of the original BPU in the current picture. For example, the search window can be centered at a location having the same coordinates in the reference picture as the original BPU in the current picture and can be extended out for a predetermined distance. When encoder 200 identifies (e.g., by using a pel-recursive algorithm, a block-matching algorithm, or the like) a region similar to the original BPU in the search window, encoder 200 can determine such a region as the matching region. The matching region can have different dimensions (e.g., being smaller than, equal to, larger than, or in a different shape) from the original BPU. Because the reference picture and the current picture are temporally separated in the timeline (e.g., as shown in FIG. 1), it can be deemed that the matching region “moves” to the location of the original BPU as time goes by. Encoder 200 can record the direction and distance of such a motion as a “motion vector (MV).” In other words, MV is the position difference between the reference block in the reference picture and the current block in the current picture. In inter prediction, the reference block is used as the predictor for the current block, so the reference block is also called predicted block. When multiple reference pictures are used (e.g., as picture 106 in FIG. 1), encoder 200 can search for a matching region and determine its associated MV for each reference picture. In some embodiments, encoder 200 can assign weights to pixel values of the matching regions of respective matching reference pictures.

The motion estimation can be used to identify various types of motions, such as, for example, translations, rotations, zooming, or the like. For inter prediction, prediction data 206 can include, for example, reference index, locations (e.g., coordinates) of the matching region, MVs associated with the matching region, number of reference pictures, weights associated with the reference pictures, or other motion information.

For generating predicted BPU 208, encoder 200 can perform an operation of “motion compensation.” The motion compensation can be used to reconstruct predicted BPU 208 based on prediction data 206 (e.g., the MV) and prediction reference 224. For example, encoder 200 can move the matching region of the reference picture according to the MV, in which encoder 200 can predict the original BPU of the current picture. When multiple reference pictures are used (e.g., as picture 106 in FIG. 1), encoder 200 can move the matching regions of the reference pictures according to the respective MVs and average pixel values of the matching regions. In some embodiments, if encoder 200 has assigned weights to pixel values of the matching regions of respective matching reference pictures, encoder 200 can add a weighted sum of the pixel values of the moved matching regions.

In some embodiments, the inter prediction can utilize uni-prediction or bi-prediction and be unidirectional or bidirectional. Unidirectional inter predictions can use one or more reference pictures in the same temporal direction with respect to the current picture. For example, picture 104 in FIG. 1 is a unidirectional inter-predicted picture, in which the reference picture (i.e., picture 102) precedes picture 104. In uni-prediction, only one MV pointing to one reference picture is used to generate the prediction signal for the current block.

On the other hand, bidirectional inter predictions can use one or more reference pictures at both temporal directions with respect to the current picture. For example, picture 106 in FIG. 1 is a bidirectional inter-predicted picture, in which the reference pictures (e.g., pictures 104 and 108) are at opposite temporal directions with respect to picture 104. In bi-prediction, two MVs, each pointing to its own reference picture, are used to generate the prediction signal of the current block. After video bitstream 228 is generated, MVs and reference indices can be sent in video bitstream 228 to a decoder, to identify where the prediction signal(s) of the current block come from.

For inter-predicted CUs, motion parameters may include MVs, reference picture indices and reference picture list usage index, or other additional information needed for coding features to be used. Motion parameters can be signaled in an explicit or implicit manner. In some embodiments, under some specific inter coding modes, such as a skip mode or a direct mode, motion parameters (e.g., MV difference and reference picture index) are not coded and signaled in video bitstream 228. Instead, the motion parameters can be derived at the decoder side with the same rule as defined in encoder 200. Details of the skip mode and the direct mode will be discussed in the paragraphs below.

After intra prediction stage 2042 and inter prediction stage 2044, at mode decision stage 230, encoder 200 can select a prediction mode (e.g., one of the intra prediction or the inter prediction) for the current iteration of process. For example, encoder 200 can perform a rate-distortion optimization method, in which encoder 200 can select a prediction mode to minimize a value of a cost function depending on a bit rate of a candidate prediction mode and distortion of the reconstructed reference picture under the candidate prediction mode. Depending on the selected prediction mode, encoder 200 can generate the corresponding predicted BPU 208 (e.g., a prediction block) and prediction data 206.

In some embodiments, predicted BPU 208 can be identical to the original BPU. However, due to non-ideal prediction and reconstruction operations, predicted BPU 208 is generally slightly different from the original BPU. For recording such differences, after generating predicted BPU 208, encoder 200 can subtract it from the original BPU to generate residual BPU 210, which is also called a prediction residual.

For example, encoder 200 can subtract values (e.g., greyscale values or RGB values) of pixels of predicted BPU 208 from values of corresponding pixels of the original BPU. Each pixel of residual BPU 210 can have a residual value as a result of such subtraction between the corresponding pixels of the original BPU and predicted BPU 208. Compared with the original BPU, prediction data 206 and residual BPU 210 can have fewer bits, but they can be used to reconstruct the original BPU without significant quality deterioration. Thus, the original BPU is compressed.

After residual BPU 210 is generated, encoder 200 can feed residual BPU 210 to transform stage 212 and quantization stage 214 to generate quantized residual coefficients 216. To further compress residual BPU 210, at transform stage 212, encoder 200 can reduce spatial redundancy of residual BPU 210 by decomposing it into a set of two-dimensional “base patterns,” each base pattern being associated with a “transform coefficient.” The base patterns can have the same size (e.g., the size of residual BPU 210). Each base pattern can represent a variation frequency (e.g., frequency of brightness variation) component of residual BPU 210. None of the base patterns can be reproduced from any combinations (e.g., linear combinations) of any other base patterns. In other words, the decomposition can decompose variations of residual BPU 210 into a frequency domain. Such a decomposition is analogous to a discrete Fourier transform of a function, in which the base patterns are analogous to the base functions (e.g., trigonometry functions) of the discrete Fourier transform, and the transform coefficients are analogous to the coefficients associated with the base functions.

Different transform algorithms can use different base patterns. Various transform algorithms can be used at transform stage 212, such as, for example, a discrete cosine transform, a discrete sine transform, or the like. The transform at transform stage 212 is invertible. That is, encoder 200 can restore residual BPU 210 by an inverse operation of the transform (referred to as an “inverse transform”). For example, to restore a pixel of residual BPU 210, the inverse transform can be multiplying values of corresponding pixels of the base patterns by respective associated coefficients and adding the products to produce a weighted sum. For a video coding standard, encoder 200 and a corresponding decoder (e.g., decoder 300 in FIG. 3) can use the same transform algorithm (thus the same base patterns). Thus, encoder 200 can record only the transform coefficients, from which decoder 300 can reconstruct residual BPU 210 without receiving the base patterns from encoder 200. Compared with residual BPU 210, the transform coefficients can have fewer bits, but they can be used to reconstruct residual BPU 210 without significant quality deterioration. Thus, residual BPU 210 is further compressed.

Encoder 200 can further compress the transform coefficients at quantization stage 214. In the transform process, different base patterns can represent different variation frequencies (e.g., brightness variation frequencies). Because human eyes are generally better at recognizing low-frequency variation, encoder 200 can disregard information of high-frequency variation without causing significant quality deterioration in decoding. For example, at quantization stage 214, encoder 200 can generate quantized residual coefficients 216 by dividing each transform coefficient by an integer value (referred to as a “quantization parameter”) and rounding the quotient to its nearest integer. After such an operation, some transform coefficients of the high-frequency base patterns can be converted to zero, and the transform coefficients of the low-frequency base patterns can be converted to smaller integers. Encoder 200 can disregard the zero-value quantized residual coefficients 216, by which the transform coefficients are further compressed. The quantization process is also invertible, in which quantized residual coefficients 216 can be reconstructed to the transform coefficients in an inverse operation of the quantization (referred to as “inverse quantization”).

Because encoder 200 disregards the remainders of such divisions in the rounding operation, quantization stage 214 can be lossy. Typically, quantization stage 214 can contribute the most information loss in the encoding process. The larger the information loss is, the fewer bits the quantized residual coefficients 216 can need. For obtaining different levels of information loss, encoder 200 can use different values of the quantization parameter or any other parameter of the quantization process.

Encoder 200 can feed prediction data 206 and quantized residual coefficients 216 to binary coding stage 226 to generate video bitstream 228 to complete the forward path. At binary coding stage 226, encoder 200 can encode prediction data 206 and quantized residual coefficients 216 using a binary coding technique, such as, for example, entropy coding, variable length coding, arithmetic coding, Huffman coding, context-adaptive binary arithmetic coding (CABAC), or any other lossless or lossy compression algorithm.

For example, the encoding process of CABAC in binary coding stage 226 may include a binarization step, a context modeling step, and a binary arithmetic coding step. If the syntax element is not binary, encoder 200 first maps the syntax element to a binary sequence. Encoder 200 may select a context coding mode or a bypass coding mode for coding. In some embodiments, for context coding mode, the probability model of the bin to be encoded is selected by the “context”, which refers to the previous encoded syntax elements. Then the bin and the selected context model is passed to an arithmetic coding engine, which encodes the bin and updates the corresponding probability distribution of the context model. In some embodiments, for the bypass coding mode, without selecting the probability model by the “context,” bins are encoded with a fixed probability (e.g., a probability equal to 0.5). In some embodiments, the bypass coding mode is selected for specific bins in order to speed up the entropy coding process with negligible loss of coding efficiency.

In some embodiments, in addition to prediction data 206 and quantized residual coefficients 216, encoder 200 can encode other information at binary coding stage 226, such as, for example, the prediction mode selected at the prediction stage (e.g., intra prediction stage 2042 or inter prediction stage 2044), parameters of the prediction operation (e.g., intra prediction mode, motion information, etc.), a transform type at transform stage 212, parameters of the quantization process (e.g., quantization parameters), an encoder control parameter (e.g., a bitrate control parameter), or the like. That is, coding information can be sent to binary coding stage 226 to further reduce the bit rate before being packed into video bitstream 228. Encoder 200 can use the output data of binary coding stage 226 to generate video bitstream 228. In some embodiments, video bitstream 228 can be further packetized for network transmission.

Components 218, 220, 222, 224, 232, and 234 can be referred to as a “reconstruction path.” The reconstruction path can be used to ensure that both encoder 200 and its corresponding decoder (e.g., decoder 300 in FIG. 3) use the same reference data for prediction.

During the process, after quantization stage 214, encoder 200 can feed quantized residual coefficients 216 to inverse quantization stage 218 and inverse transform stage 220 to generate reconstructed residual BPU 222. At inverse quantization stage 218, encoder 200 can perform inverse quantization on quantized residual coefficients 216 to generate reconstructed transform coefficients. At inverse transform stage 220, encoder 200 can generate reconstructed residual BPU 222 based on the reconstructed transform coefficients. Encoder 200 can add reconstructed residual BPU 222 to predicted BPU 208 to generate prediction reference 224 to be used in prediction stages 2042, 2044 for the next iteration of process.

In the reconstruction path, if intra prediction mode has been selected in the forward path, after generating prediction reference 224 (e.g., the current BPU that has been encoded and reconstructed in the current picture), encoder 200 can directly feed prediction reference 224 to intra prediction stage 2042 for later usage (e.g., for extrapolation of a next BPU of the current picture). If the inter prediction mode has been selected in the forward path, after generating prediction reference 224 (e.g., the current picture in which all BPUs have been encoded and reconstructed), encoder 200 can feed prediction reference 224 to loop filter stage 232, at which encoder 200 can apply a loop filter to prediction reference 224 to reduce or eliminate distortion (e.g., blocking artifacts) introduced by the inter prediction. Encoder 200 can apply various loop filter techniques at loop filter stage 232, such as, for example, deblocking, sample adaptive offsets (SAO), adaptive loop filters (ALF), or the like. In SAO, a nonlinear amplitude mapping is introduced within the inter prediction loop after the deblocking filter to reconstruct the original signal amplitudes with a look-up table that is described by a few additional parameters determined by histogram analysis at the encoder side.

The loop-filtered reference picture can be stored in buffer 234 (or “decoded picture buffer”) for later use (e.g., to be used as an inter-prediction reference picture for a future picture of video sequence 202). Encoder 200 can store one or more reference pictures in buffer 234 to be used at inter prediction stage 2044. In some embodiments, encoder 200 can encode parameters of the loop filter (e.g., a loop filter strength) at binary coding stage 226, along with quantized residual coefficients 216, prediction data 206, and other information.

Encoder 200 can perform the process discussed above iteratively to encode each original BPU of the original picture (in the forward path) and generate prediction reference 224 for encoding the next original BPU of the original picture (in the reconstruction path). After encoding all original BPUs of the original picture, encoder 200 can proceed to encode the next picture in video sequence 202.

It should be noted that other variations of the encoding process can be used to encode video sequence 202. In some embodiments, stages of process can be performed by encoder 200 in different orders. In some embodiments, one or more stages of the encoding process can be combined into a single stage. In some embodiments, a single stage of the encoding process can be divided into multiple stages. For example, transform stage 212 and quantization stage 214 can be combined into a single stage. In some embodiments, the encoding process can include additional stages that are not shown in FIG. 2. In some embodiments, the encoding process can omit one or more stages in FIG. 2.

For example, in some embodiments, encoder 200 can be operated in a transform skipping mode. In the transform skipping mode, transform stage 212 is bypassed and a transform skip flag is signaled for the TB. This may improve compression for some types of video content such as computer-generated images or graphics mixed with camera-view content (e.g., scrolling text). In addition, encoder 200 can also be operated in a lossless mode. In the lossless mode, transform stage 212, quantization stage 214, and other processing that affects the decoded picture (e.g., SAO and deblocking filters) are bypassed. The residual signal from the intra prediction stage 2042 or inter prediction stage 2044 is fed into binary coding stage 226, using the same neighborhood contexts applied to the quantized transform coefficients. This allows mathematically lossless reconstruction. Therefore, both transform and transform skip residual coefficients are coded within non-overlapped CGs. That is, each CG may include one or more transform residual coefficients, or one or more transform skip residual coefficients.

FIG. 3 illustrates a block diagram of an example decoder 300 of a video coding system (e.g., AVS3 or H.26x series), according to some embodiments of the present disclosure. Decoder 300 can perform a decompression process corresponding to the compression process in FIG. 2. The corresponding stages in the compression process and decompression process are labeled with the same numbers in FIG. 2 and FIG. 3.

In some embodiments, the decompression process can be similar to the reconstruction path in FIG. 2. Decoder 300 can decode video bitstream 228 into video stream 304 accordingly. Video stream 304 can be very similar to video sequence 202 in FIG. 2. However, due to the information loss in the compression and decompression process (e.g., quantization stage 214 in FIG. 2), video stream 304 may not be identical to video sequence 202. Similar to encoder 200 in FIG. 2, decoder 300 can perform the decoding process at the level of basic processing units (BPUs) for each picture encoded in video bitstream 228. For example, decoder 300 can perform the process in an iterative manner, in which decoder 300 can decode a basic processing unit in one iteration. In some embodiments, decoder 300 can perform the decoding process in parallel for regions (e.g., slices 114-118) of each picture encoded in video bitstream 228.

In FIG. 3, decoder 300 can feed a portion of video bitstream 228 associated with a basic processing unit (referred to as an “encoded BPU”) of an encoded picture to binary decoding stage 302. At binary decoding stage 302, decoder 300 can unpack and decode video bitstream into prediction data 206 and quantized residual coefficients 216. Decoder 300 can use prediction data 206 and quantized residual coefficients to reconstruct video stream 304 corresponding to video bitstream 228.

Decoder 300 can perform an inverse operation of the binary coding technique used by encoder 200 (e.g., entropy coding, variable length coding, arithmetic coding, Huffman coding, context-adaptive binary arithmetic coding, or any other lossless compression algorithm) at binary decoding stage 302. In some embodiments, in addition to prediction data 206 and quantized residual coefficients 216, decoder 300 can decode other information at binary decoding stage 302, such as, for example, a prediction mode, parameters of the prediction operation, a transform type, parameters of the quantization process (e.g., quantization parameters), an encoder control parameter (e.g., a bitrate control parameter), or the like. In some embodiments, if video bitstream 228 is transmitted over a network in packets, decoder 300 can depacketize video bitstream 228 before feeding it to binary decoding stage 302.

Decoder 300 can feed quantized residual coefficients 216 to inverse quantization stage 218 and inverse transform stage 220 to generate reconstructed residual BPU 222. Decoder 300 can feed prediction data 206 to intra prediction stage 2042 and inter prediction stage 2044 to generate predicted BPU 208. Particularly, for an encoded basic processing unit (referred to as a “current BPU”) of an encoded picture (referred to as a “current picture”) that is being decoded, prediction data 206 decoded from binary decoding stage 302 by decoder 300 can include various types of data, depending on what prediction mode was used to encode the current BPU by encoder 200. For example, if intra prediction was used by encoder 200 to encode the current BPU, prediction data 206 can include coding information such as a prediction mode indicator (e.g., a flag value) indicative of the intra prediction, parameters of the intra prediction operation, or the like. The parameters of the intra prediction operation can include, for example, locations (e.g., coordinates) of one or more neighboring BPUs used as a reference, sizes of the neighboring BPUs, parameters of extrapolation, a direction of the neighboring BPUs with respect to the original BPU, or the like. For another example, if inter prediction was used by encoder 200 to encode the current BPU, prediction data 206 can include coding information such as a prediction mode indicator (e.g., a flag value) indicative of the inter prediction, parameters of the inter prediction operation, or the like. The parameters of the inter prediction operation can include, for example, the number of reference pictures associated with the current BPU, weights respectively associated with the reference pictures, locations (e.g., coordinates) of one or more matching regions in the respective reference pictures, one or more MVs respectively associated with the matching regions, or the like.

Accordingly, the prediction mode indicator can be used to select whether inter or intra prediction module will be invoked. Then, parameters of the corresponding prediction operation can be sent to the corresponding prediction module to generate the prediction signal(s). Particularly, based on the prediction mode indicator, decoder 300 can decide whether to perform an intra prediction at intra prediction stage 2042 or an inter prediction at inter prediction stage 2044. The details of performing such intra prediction or inter prediction are described in FIG. 2 and will not be repeated hereinafter. After performing such intra prediction or inter prediction, decoder 300 can generate predicted BPU 208.

After predicted BPU 208 is generated, decoder 300 can add reconstructed residual BPU 222 to predicted BPU 208 to generate prediction reference 224. In some embodiments, prediction reference 224 can be stored in a buffer (e.g., a decoded picture buffer in a computer memory). Decoder 300 can feed prediction reference 224 to intra prediction stage 2042 and inter prediction stage 2044 for performing a prediction operation in the next iteration.

For example, if the current BPU is decoded using the intra prediction at intra prediction stage 2042, after generating prediction reference 224 (e.g., the decoded current BPU), decoder 300 can directly feed prediction reference 224 to intra prediction stage 2042 for later usage (e.g., for extrapolation of a next BPU of the current picture). If the current BPU is decoded using the inter prediction at inter prediction stage 2044, after generating prediction reference 224 (e.g., a reference picture in which all BPUs have been decoded), decoder 300 can feed prediction reference 224 to loop filter stage 232 to reduce or eliminate distortion (e.g., blocking artifacts). In addition, prediction data 206 can further include parameters of a loop filter (e.g., a loop filter strength). Accordingly, decoder 300 can apply the loop filter to prediction reference 224, in a way as described in FIG. 2. For example, loop filters such as deblocking, SAO or ALF may be applied to form the loop-filtered reference picture, which are stored in buffer 234 (e.g., a decoded picture buffer (DPB) in a computer memory) for later use (e.g., to be used at inter prediction stage 2044 for prediction of a future encoded picture of video bitstream 228). In some embodiments, reconstructed pictures from buffer 234 can also be sent to a display, such as a TV, a PC, a smartphone, or a tablet to be viewed by the end-users.

Decoder 300 can perform the decoding process iteratively to decode each encoded BPU of the encoded picture and generate prediction reference 224 for encoding the next encoded BPU of the encoded picture. After decoding all encoded BPUs of the encoded picture, decoder 300 can output the picture to video stream 304 for display and proceed to decode the next encoded picture in video bitstream 228.

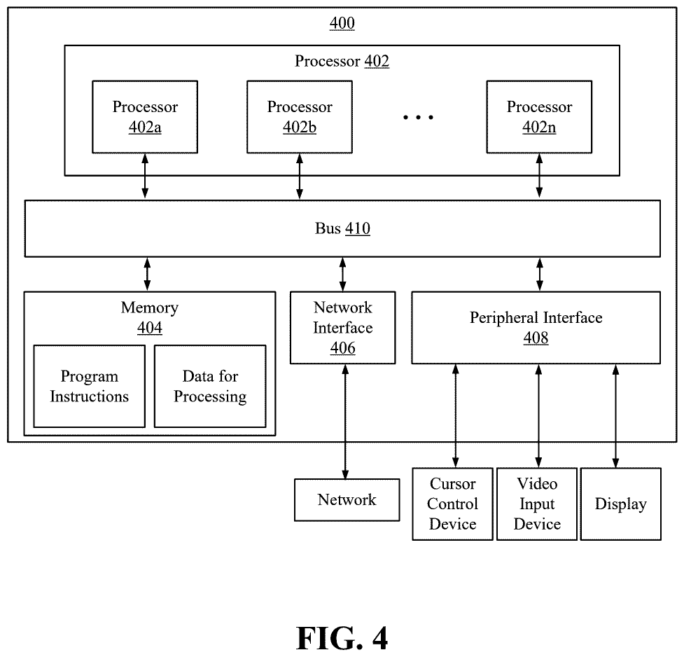

FIG. 4 is a block diagram of an example apparatus 400 for encoding or decoding a video, according to some embodiments of the present disclosure. As shown in FIG. 4, apparatus 400 can include processor 402. When processor 402 executes instructions described herein, apparatus 400 can become a specialized machine for video encoding or decoding. Processor 402 can be any type of circuitry capable of manipulating or processing information. For example, processor 402 can include any combination of any number of a central processing unit (or “CPU”), a graphics processing unit (or “GPU”), a neural processing unit (“NPU”), a microcontroller unit (“MCU”), an optical processor, a programmable logic controller, a microcontroller, a microprocessor, a digital signal processor, an intellectual property (IP) core, a Programmable Logic Array (PLA), a Programmable Array Logic (PAL), a Generic Array Logic (GAL), a Complex Programmable Logic Device (CPLD), a Field-Programmable Gate Array (FPGA), a System On Chip (SoC), an Application-Specific Integrated Circuit (ASIC), or the like. In some embodiments, processor 402 can also be a set of processors grouped as a single logical component. For example, as shown in FIG. 4, processor 402 can include multiple processors, including processor 402a, processor 402b, and processor 402n.

Apparatus 400 can also include memory 404 configured to store data (e.g., a set of instructions, computer codes, intermediate data, or the like). For example, as shown in FIG. 4, the stored data can include program instructions (e.g., program instructions for implementing the stages in FIG. 2 and FIG. 3) and data for processing (e.g., video sequence 202, video bitstream 228, or video stream 304). Processor 402 can access the program instructions and data for processing (e.g., via bus 410), and execute the program instructions to perform an operation or manipulation on the data for processing. Memory 404 can include a high-speed random-access storage device or a non-volatile storage device. In some embodiments, memory 404 can include any combination of any number of a random-access memory (RAM), a read-only memory (ROM), an optical disc, a magnetic disk, a hard drive, a solid-state drive, a flash drive, a security digital (SD) card, a memory stick, a compact flash (CF) card, or the like. Memory 404 can also be a group of memories (not shown in FIG. 4) grouped as a single logical component.

Bus 410 can be a communication device that transfers data between components inside apparatus 400, such as an internal bus (e.g., a CPU-memory bus), an external bus (e.g., a universal serial bus port, a peripheral component interconnect express port), or the like.

For ease of explanation without causing ambiguity, processor 402 and other data processing circuits are collectively referred to as a “data processing circuit” in the present disclosure. The data processing circuit can be implemented entirely as hardware, or as a combination of software, hardware, or firmware. In addition, the data processing circuit can be a single independent module or can be combined entirely or partially into any other component of apparatus 400.

Apparatus 400 can further include network interface 406 to provide wired or wireless communication with a network (e.g., the Internet, an intranet, a local area network, a mobile communications network, or the like). In some embodiments, network interface 406 can include any combination of any number of a network interface controller (NIC), a radio frequency (RF) module, a transponder, a transceiver, a modem, a router, a gateway, a wired network adapter, a wireless network adapter, a Bluetooth adapter, an infrared adapter, an near-field communication (“NFC”) adapter, a cellular network chip, or the like.

In some embodiments, optionally, apparatus 400 can further include peripheral interface 408 to provide a connection to one or more peripheral devices. As shown in FIG. 4, the peripheral device can include, but is not limited to, a cursor control device (e.g., a mouse, a touchpad, or a touchscreen), a keyboard, a display (e.g., a cathode-ray tube display, a liquid crystal display, or a light-emitting diode display), a video input device (e.g., a camera or an input interface coupled to a video archive), or the like.

It should be noted that video codecs (e.g., a codec performing process of encoder 200 or decoder 300) can be implemented as any combination of any software or hardware modules in apparatus 400. For example, some or all stages of process encoder 200 or decoder 300 can be implemented as one or more software modules of apparatus 400, such as program instructions that can be loaded into memory 404. For another example, some or all stages of process encoder 200 or decoder 300 can be implemented as one or more hardware modules of apparatus 400, such as a specialized data processing circuit (e.g., an FPGA, an ASIC, an NPU, or the like).

In the inter prediction stage 2044 in FIG. 2 and FIG. 3, reference index is used to indicate which previously coded picture the reference block is from. The motion vector (MV), the position difference between the reference block in the reference picture and the current block in the current picture, is used to indicate the position of the reference block in the reference picture. For bi-prediction (e.g., picture 106 in FIG. 1), two reference blocks, one from a reference picture in reference picture List 0 (e.g., picture 104) and the other from a reference picture in reference picture List 1 (e.g., picture 108) are used to generate the combined predicted block. Accordingly, two reference indices, (e.g., List 0 reference index and List 1 reference index), and two motion vectors (e.g., List 0 motion vector and List 1 motion vector) are required for bi-prediction. The motion vector is determined by the encoder and signaled to the decoder. In some embodiments, to save the signaling cost, a motion vector difference (MVD) is signaled in the bitstream instead. For a decoder, a motion vector predictor (MVP) can be derived based on the spatial and temporal neighboring block motion information, and the MV can be obtained by adding the MVD parsed from the bitstream to the MVP.

As discussed above, the video encoding or decoding process can be achieved using different modes. In some normal inter coding modes, encoder 200 can signal MV(s), corresponding reference picture index for each reference picture list and reference picture list usage flag, or other information explicitly per each CU. On the other hand, when a CU is coded with a skip mode or a direct mode, the motion information, including reference index and motion vector, is not signaled in video bitstream 228 to decoder 300. Instead, the motion information can be derived at decoder 300 using the same rule as encoder 200 does. The skip mode and the direct mode share the same motion information derivation rule and thus have the same motion information. A difference between these two modes is that in the skip mode, the signaling of the prediction residuals is skipped by setting residuals to be zero. In the direct mode, prediction residuals are still signaled in the bitstream.

For example, when a CU is coded with a skip mode, the CU is associated with one PU and has no significant residual coefficients, no coded MV difference or reference picture index. In the skip mode, the signaling of the residual data can be skipped by setting residuals to be zero. In the direct mode, the residual data is transmitted while the motion information and partitions are derived.

On the other hand, in inter modes, encoder 200 can choose any allowed values for motion vector and reference index as the motion vector difference and reference index are signaled to decoder 300. Compared with inter modes signaling the motion information, the bits dedicated on the motion information can thus be saved in the skip mode or the direct mode. However, encoder 200 and decoder 300 need to follow the same rule to derive the motion vector and reference index to perform inter prediction 2044. In some embodiments, the derivation of the motion information can be based on the spatial or temporal neighboring block. Accordingly, the skip mode and the direct mode are suitable for the case where the motion information of the current block is close to that of the spatial or temporal neighboring blocks of the current block.

For example, the skip mode or the direct mode may enable the motion information (e.g., reference index, MVs, etc.) to be inherited from a spatial or temporal (co-located) neighbor. A candidate list of motion candidates can be generated from these neighbors. In some embodiments, to derive the motion information used for inter prediction 2044 in skip mode or direct mode, encoder 200 may first derive the candidate list of motion candidates and select one of the motion candidates to perform inter prediction 2044. When signaling video bitstream 228, encoder 200 may signal an index of the selected candidate. At the decoder side, decoder 300 can obtain the index parsed from video bitstream 228, derive the same candidate list, and use the same motion candidate (including motion vector and reference picture index) to perform inter prediction 2044.

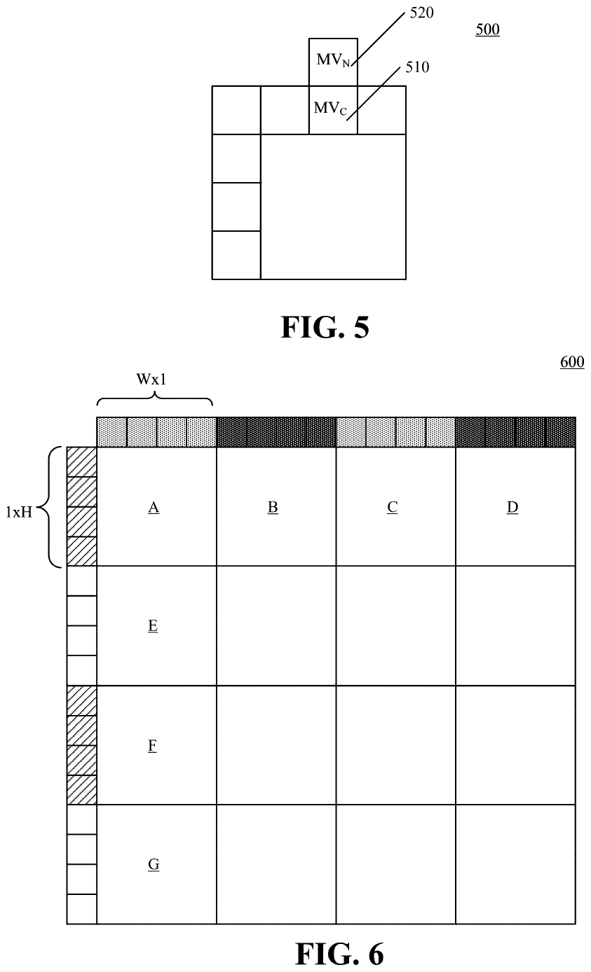

FIG. 5 is a schematic diagram illustrating top and left CU boundaries of Overlapped Block Motion Compensation (OBMC) performed at a 4×4 sub-block level, according to some embodiments of the present disclosure. Overlapped Block Motion Compensation (OBMC) is an inter coding tool used in ECM. When OBMC is applied to a CU 500, it is performed for the top and/or left boundaries of the CU 500. Moreover, when the CU 500 is coded with a sub-CU mode (e.g., affine mode and DMVR mode), the OBMC will be further performed for the boundaries of each sub-CU within the CU 500, except for the boundaries of the CU 500. To process boundaries in a uniform fashion, OBMC is performed at a 4×4 sub-block level for all enabled boundaries. OBMC is applied for both the luma and chroma components.

For the top and left CU boundaries, OBMC is performed at a 4×4 sub-block level as shown in FIG. 5. When OBMC applies to the current sub-block 510, besides current motion vector MV_{C}, a motion vector MV_{N} from top neighboring sub-block 520 when the current sub-block is in the top boundary (or a motion vector MV_{N}, from left neighboring sub-block when the current sub-block is in the left boundary), if available and is not identical to the current motion vector MV_{C}, is also used to derive prediction block for the current sub-block 510. The prediction signal based on the current motion vector MV_{C} which is denoted as pred_{C}, and the prediction signal based on the neighboring motion vector MV_{N} which is denoted as pred_{N}, are blended to generate the final prediction signal of the current sub-block pred. If MV_{N} is equal to MV_{C}, the OBMC is not performed for the current sub-block 510.

In the early ECM, a set of fixed weights are used for blending. For sub-blocks in top boundary, the samples in the same row share the same weights, for sub-blocks in left boundary, the samples in the same column share the same weights. The weights are shown in Equation 1, where coordinates (i, j) represent the horizontal distance i and vertical distance j between the current chroma sample and the chroma sample in the top left corner of the current 4×4 sub-block.

$$\begin{matrix}for top boundary \{ \begin{matrix}pred ( i , 0 ) = ( 26 * {pred}_{C} ( i , 0 ) + 6 * {pred}_{N} ( i , 0 ) + 16 ) ≫ 5 ) , 0 \leq i < 4 \\ pred ( i , 1 ) = ( 7 * {pred}_{C} ( i , 1 ) + 1 * {pred}_{N} ( i , 1 ) + 4 ) ≫ 3 ) , 0 \leq i < 4 \\ pred ( i , 2 ) = ( 15 * {pred}_{C} ( i , 2 ) + 1 * {pred}_{N} ( i , 2 ) + 8 ) ≫ 4 ) , 0 \leq i < 4 \\ pred ( i , 3 ) = ( 31 * {pred}_{C} ( i , 3 ) + 1 * {pred}_{N} ( i , 3 ) + 16 ) ≫ 5 ) , 0 \leq i < 4\end{matrix} \\ for left boundary \{ \begin{matrix}pred ( 0 , j ) = ( 26 * {pred}_{C} ( 0 , j ) + 6 * {pred}_{N} ( 0 , j ) + 16 ) ≫ 5 ) , 0 \leq j < 4 \\ pred ( 1 , j ) = ( 7 * {pred}_{C} ( 1 , j ) + 1 * {pred}_{N} ( 1 , j ) + 4 ) ≫ 3 ) , 0 \leq j < 4 \\ pred ( 2 , j ) = ( 15 * {pred}_{C} ( 2 , j ) + 1 * {pred}_{N} ( 2 , j ) + 8 ) ≫ 4 ) , 0 \leq j < 4 \\ pred ( 3 , j ) = ( 31 * {pred}_{C} ( 3 , j ) + 1 * {pred}_{N} ( 3 , j ) + 16 ) ≫ 5 ) , 0 \leq j < 4\end{matrix}\end{matrix} \qquad ( Equation 1 )$$

In some embodiments, a template matching-based OBMC scheme is adopted. FIG. 6 is a schematic diagram illustrating a template matching-based OBMC scheme, according to some embodiments of the present disclosure. As shown in FIG. 6, for each top block (e.g., blocks A, B, C, and D) with a size of 4×4 at the top CU boundary, the above template size equals to 4×1. If an adjacent blocks have the same motion information, then the above template size is merged to 4N×1 since the motion compensation operation can be processed at one time. Similarly, for each left block (e.g., blocks A, E, F, and G) with a size of 4×4 at the left CU boundary, the left template size equals to 1×4 or 1×4N.

Using block A as the current block and its above neighboring block AboveNeighbor_A as an example, the prediction value of boundary samples for each 4×4 top sub-block (or N 4×4 blocks group) can be derived by the following steps. The same method and operations also apply to left blocks.

First, three template matching costs (Cost1, Cost2, Cost3) are measured by the sum of absolute difference (SAD) between the reconstructed samples of a template and its corresponding reference samples derived by motion compensation process according to the following three types of motion information. The first template matching cost Cost1 is calculated according to A's motion information. The second template matching cost Cost2 is calculated according to AboveNeighbor_A's motion information. The third template matching cost Cost3 is calculated according to weighted prediction of A's and AboveNeighbor_A's motion information with weighting factors as ¾ and ¼ respectively.

Next, the final prediction results for boundary samples can be determined by comparing the template matching costs Cost1, Cost2, and Cost3. For example, if the first template matching cost Cost1 is the minimum, then pred(i, j)=pred_{C}(i, j), which means OBMC is not performed. If (Cost2+(Cost2>>2)+(Cost2>>3))<=Cost1, then the first blending mode can be used as shown in Equation 1. If Cost1<=Cost2, then the second blending mode can be used as shown in Equation 3 below. Otherwise, the third blending mode can be used as shown in Equation 2 below. In some embodiments, for chroma samples, only the first row or column can perform blending.

$$\begin{matrix}for top boundary \{ \begin{matrix}pred ( i , 0 ) = ( 7 * {pred}_{C} ( i , 0 ) + 1 * {pred}_{N} ( i , 0 ) + 4 ) ≫ 3 ) , 0 \leq i < 4 \\ pred ( i , 1 ) = ( 15 * {pred}_{C} ( i , 1 ) + 1 * {pred}_{N} ( i , 1 ) + 8 ) ≫ 4 ) , 0 \leq i < 4 \\ pred ( i , 2 ) = ( 31 * {pred}_{C} ( i , 2 ) + 1 * {pred}_{N} ( i , 2 ) + 16 ) ≫ 5 ) , 0 \leq i < 4 \\ pred ( i , 3 ) = {pred}_{C} ( i , 3 ) , 0 \leq i < 4\end{matrix} \\ for left boundary \{ \begin{matrix}pred ( 0 , j ) = ( 7 * {pred}_{C} ( 0 , j ) + 1 * {pred}_{N} ( 0 , j ) + 4 ) ≫ 3 ) , 0 \leq j < 4 \\ pred ( 1 , j ) = ( 15 * {pred}_{C} ( 1 , j ) + 1 * {pred}_{N} ( 1 , j ) + 8 ) ≫ 4 ) , 0 \leq j < 4 \\ pred ( 2 , j ) = ( 31 * {pred}_{C} ( 2 , j ) + 1 * {pred}_{N} ( 2 , j ) + 16 ) ≫ 5 ) , 0 \leq j < 4 \\ pred ( 3 , j ) = {pred}_{C} ( 3 , j ) , 0 \leq j < 4\end{matrix}\end{matrix} \qquad ( Equation 2 )$$

$$\begin{matrix}for top boundary \{ \begin{matrix}pred ( i , 0 ) = ( 15 * {Pred}_{C} ( i , 0 ) + 1 * {Pred}_{N} ( i , 0 ) + 8 ) ≫ 4 ) , 0 \leq i < 4 \\ pred ( i , 1 ) = ( 31 * {Pred}_{C} ( i , 1 ) + 1 * {Pred}_{N} ( i , 1 ) + 16 ) ≫ 5 ) , 0 \leq i < 4 \\ pred ( i , 2 ) = {Pred}_{C} ( i , 2 ) , 0 \leq i < 4 \\ pred ( i , 3 ) = {Pred}_{C} ( i , 3 ) , 0 \leq i < 4\end{matrix} \\ for left boundary \{ \begin{matrix}pred ( 0 , j ) = ( 15 * {Pred}_{C} ( 0 , j ) + 1 * {Pred}_{N} ( 0 , j ) + 8 ) ≫ 4 ) , 0 \leq j < 4 \\ pred ( 1 , j ) = ( 31 * {Pred}_{C} ( 1 , j ) + 1 * {Pred}_{N} ( 1 , j ) + 16 ) ≫ 5 ) , 0 \leq j < 4 \\ pred ( 2 , j ) = {Pred}_{C} ( 2 , j ) , 0 \leq j < 4 \\ pred ( 3 , j ) = {Pred}_{C} ( 3 , j ) , 0 \leq j < 4\end{matrix}\end{matrix} \qquad ( Equation 3 )$$

For sub-CU boundaries, OBMC is performed at a 4×4 sub-block level except for the CU boundaries. For each sub-block, besides current motion vectors, motion vectors of four connected neighboring sub-blocks, if available and are not identical to the current motion vector, are also used to derive prediction block for the current sub-block. These multiple prediction blocks based on multiple motion vectors are combined to generate the final prediction signal of the current sub-block.

For an Advanced Motion Vector Prediction (AMVP) mode, a flag is signaled to indicate whether to perform OBMC for a CU. In some embodiments, for skip and merge modes, OBMC can be always performed without any signaling.

In some embodiments, OBMC can be controlled by a SPS flag, which can be set based on the hash block hit percentage at the encoder side. If the hash block hit percentage is larger than a threshold, the video sequence can be interpreted as screen content and the OBMC is not applied.

In some embodiments, OBMC is not applied to a block when there is a neighbor block coded with IBC, palette, or BDPCM modes.

In some embodiments, when OBMC is applied to a sub-block, a sub-block boundary check is performed to determine whether OBMC is applied to the boundary based on the reference samples of the current sub-block. If any absolute difference between the prediction sample and non-interpolated (integer pel) reference sample is greater than a threshold, the OBMC is not applied to that boundary.

Intra block copy (IBC) is a tool adopted in VVC. IBC can significantly improve the coding efficiency of screen content materials. Since an IBC mode is implemented as a block level coding mode, block matching (BM) is performed at the encoder to find the optimal block vector (or motion vector) for each CU. In some embodiments, a block vector is used to indicate the displacement from the current block to a reference block, which is already reconstructed inside the current picture. The luma block vector of an IBC-coded CU is in integer precision. The chroma block vector rounds to integer precision as well. When combined with AMVR, the IBC mode can switch between 1-pel and 4-pel motion vector precisions. An IBC-coded CU is treated as the third prediction mode other than intra or inter prediction modes. The IBC mode is applicable to the CUs with both width and height smaller than or equal to 64 luma samples.

At the encoder side, hash-based motion estimation is performed for IBC. The encoder performs RD check for blocks with either width or height no larger than 16 luma samples. For non-merge mode, the block vector search is performed using hash-based search first. If hash search does not return valid candidate, block matching based local search will be performed.

In the hash-based search, hash key matching (32-bit CRC) between the current block and a reference block is extended to all allowed block sizes. In some embodiments, the hash key calculation for every position in the current picture can be based on 4×4 subblocks. For the current block of a larger size, a hash key is determined to match that of the reference block when all the hash keys of all 4×4 subblocks match the hash keys in the corresponding reference locations. If hash keys of multiple reference blocks are found to match that of the current block, the block vector costs of each matched reference are calculated and the one with the minimum cost is selected.

In the block matching search, the search range is set to cover both the previous and current CTUs.

At CU level, IBC mode is signaled with a flag, and it can be signaled as IBC AMVP mode or IBC skip/merge mode as follows. For IBC skip/merge mode, a merge candidate index is used to indicate which of the block vectors in the list from neighboring candidate IBC coded blocks is used to predict the current block. The merge list includes spatial, HMVP, and pairwise candidates. For IBC AMVP mode, block vector difference is coded in the same way as a motion vector difference. The block vector prediction method uses two candidates as predictors, one from left neighbor and one from above neighbor (if IBC coded). When either neighbor is not available, a default block vector can be used as a predictor. A flag is signaled to indicate the block vector predictor index.

To reduce memory consumption and decoder complexity, the IBC in VVC allows only the reconstructed portion of the predefined area including the region of current CTU and some region of the left CTU. FIG. 5 illustrates the reference region of IBC Mode, where each block represents 64×64 luma sample unit.

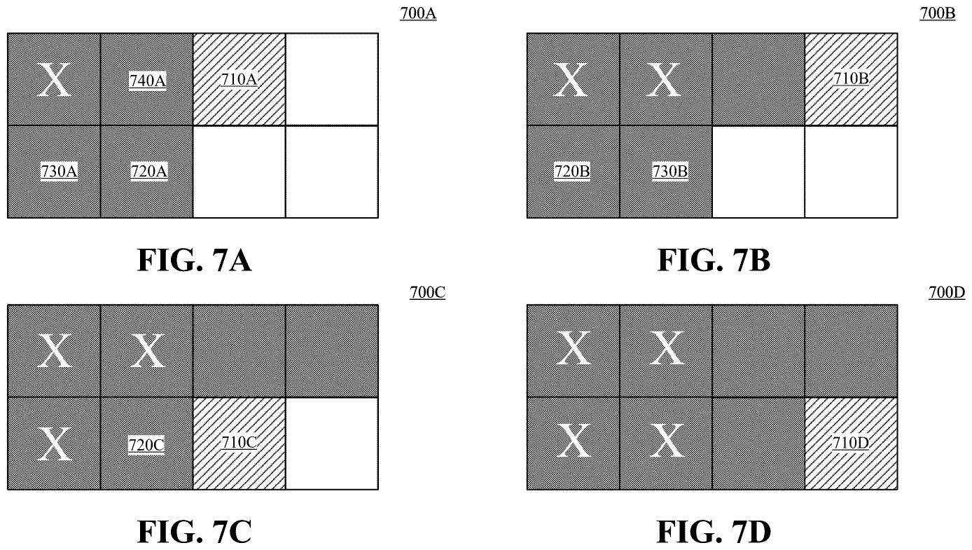

FIGS. 7A-7D are schematic diagrams illustrating reference regions of an Intra Block Copy (IBC) mode, according to some embodiments of the present disclosure. As shown in FIGS. 7A-7D, depending on the location of the current coding CU location within the current CTU, the following applies. As shown in FIG. 7A, if the current block falls into the top-left 64×64 block 710A of the current CTU 700A, then in addition to the already reconstructed samples in the current CTU, it can also refer to the reference samples in the bottom-right 64×64 blocks 720A of the left CTU, using CPR mode. The current block can also refer to the reference samples in the bottom-left 64×64 block 730A of the left CTU and the reference samples in the top-right 64×64 block 740A of the left CTU, using CPR mode.

As shown in FIG. 7B, if the current block falls into the top-right 64×64 block 710B of the current CTU 700B, then in addition to the already reconstructed samples in the current CTU, if luma location (0, 64) relative to the current CTU has not yet been reconstructed, the current block can also refer to the reference samples in the bottom-left 64×64 block 720B and bottom-right 64×64 block 730B of the left CTU, using CPR mode; otherwise, the current block can also refer to reference samples in bottom-right 64×64 block 730B of the left CTU.

As shown in FIG. 7C, if the current block falls into the bottom-left 64×64 block 710C of the current CTU 700C, then in addition to the already reconstructed samples in the current CTU, if luma location (64, 0) relative to the current CTU has not yet been reconstructed, the current block can also refer to the reference samples in the top-right 64×64 block and bottom-right 64×64 block of the left CTU, using CPR mode. Otherwise, the current block can also refer to the reference samples in the bottom-right 64×64 block 720C of the left CTU, using CPR mode.

As shown in FIG. 7D, if current block falls into the bottom-right 64×64 block 710D of the current CTU 700D, it can only refer to the already reconstructed samples in the current CTU, using CPR mode.

The above restriction allows the IBC mode to be implemented using local on-chip memory for hardware implementations.

The option of block vector resolutions is extended to include quarter-pel resolution in additional to full-pel and 4-pel. Like inter AMVR syntax, the first bin is signalled to indicate whether BV is in quarter-pel resolution, and the second bin is signalled to switch between full-pel and 4-pel resolutions. The interpolation filters applied to the luma (8-tap) and chroma (6-tap existed inter interpolation) components of an IBC block. For template-based IBC tools, a 2-tap bilinear interpolation filter is applied to generate template prediction blocks. Reference sample padding is performed when some of them are located outside IBC reference area. When needed, it performs in horizontal direction first and then vertical direction.

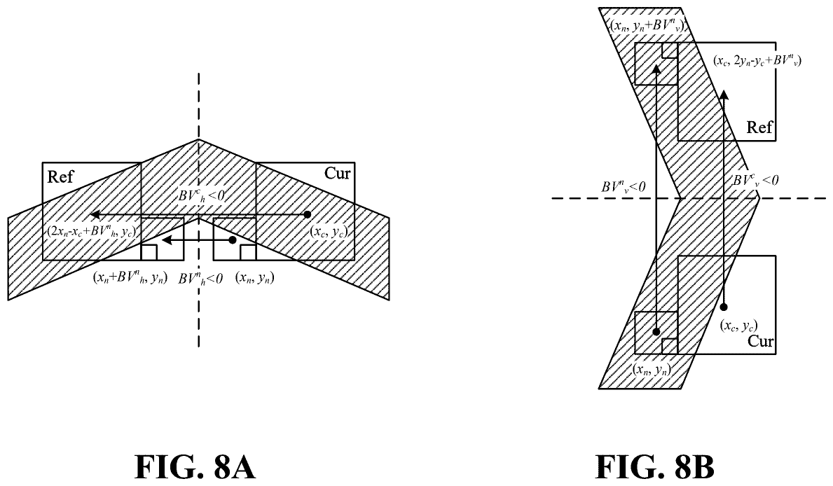

FIGS. 8A-8B are schematic diagrams illustrating block vector (BV) adjustment for horizontal flip and BV adjustment for vertical flip, according to some embodiments of the present disclosure.

In some embodiments, a Reconstruction-Reordered IBC (RR-IBC) mode is allowed for IBC coded blocks. When RR-IBC is applied, the samples in a reconstruction block are flipped according to a flip type of the current block. At the encoder side, the original block is flipped before motion search and residual calculation, while the prediction block is derived without flipping. At the decoder side, the reconstruction block is flipped back to restore the original block.

As shown in FIGS. 8A-8B, two flip methods-horizontal flip and vertical flip are supported for RR-IBC coded blocks. A syntax flag is first signaled for an IBC AMVP coded block, indicating whether the reconstruction is flipped, and if the reconstruction is flipped, another flag is further signaled specifying the flip type. For an IBC merge, the flip type is inherited from neighboring blocks, without syntax signaling. Considering the horizontal or vertical symmetry, the current block and the reference block are normally aligned horizontally or vertically. Therefore, when a horizontal flip is applied, the vertical component of the BV is not signaled and inferred to be equal to 0. Similarly, the horizontal component of the BV is not signaled and inferred to be equal to 0 when a vertical flip is applied.

To better utilize the symmetry property, a flip-aware BV adjustment approach is applied to refine the block vector candidate. For example, as shown in FIG. 8A and FIG. 8B, (xₙ, yₙ) and (x_{c}, y_{c}) represent the coordinates of the center sample of the neighboring block and the current block, respectively, BVⁿ and BV^{c} denotes the BV of the neighboring block and the current block, respectively. As shown in FIG. 8A, instead of directly inheriting the BV from a neighboring block, the horizontal component of BV^{c} is calculated by adding a motion shift to the horizontal component of BVⁿ (denoted as BVⁿₕ) in case that the neighboring block is coded with a horizontal flip, i.e., BV^{c}ₕ=2 (xₙ−x_{c})+BVⁿₕ. Similarly, as shown in FIG. 8B, the vertical component of BV^{c} is calculated by adding a motion shift to the vertical component of BVⁿ (denoted as BVⁿᵥ) in case that the neighboring block is coded with a vertical flip, i.e., BV^{c}ᵥ=2 (yₙ−y_{c})+BVⁿᵥ.

In some embodiments, combined intra block copy and intra prediction (IBC-CIIP) is a coding tool for a CU which uses IBC and intra prediction to obtain two prediction signals. The two prediction signals are weighted summed to generate the final prediction based on the following equation:

$$P = ( {w}_{ibc} * {P}_{ibc} + ( ( 1 ≪ shift ) - {w}_{ibc} ) * {P}_{intra} + ( 1 ≪ ( shift - 1 ) ) ) ≫ shift$$

wherein P_{ibc} and Pᵢₙₜᵣₐ denote the IBC prediction signal and intra prediction signal. (w_{ibc}, shift) are set equal to (13, 4) and (1, 1) for IBC merge mode and IBC AMVP mode.

In some embodiments, an intra prediction mode (IPM) candidate list is used to generate the intra prediction signal, and the IPM candidate list size is pre-defined as 2. An IPM index is signalled to indicate which IPM is used.

In some embodiments, intra block copy with geometry partitioning mode (IBC-GPM) is a coding tool which divides a CU into two sub-partitions geometrically. The prediction signals of the two sub-partitions are generated using IBC and intra prediction. IBC-GPM can be applied to regular IBC merge mode or IBC TM merge mode. In some embodiments, an intra prediction mode (IPM) candidate list is constructed, and the IPM candidate list size is pre-defined as 3. There are 48 geometry partitioning modes in total, which are divided into two geometry partitioning mode sets based on Table 1 and Table 2 below.

TABLE 1
Geometry partitioning modes in the first
geometry partitioning mode set

| ibc_gpm_partition_idx | 0 | 1 | 2 | 3 | 4 | 5 | 6 | 7 |
|---|---|---|---|---|---|---|---|---|
| angleIdx | 0 | 0 | 8 | 8 | 16 | 16 | 24 | 24 |
| distanceIdx | 1 | 3 | 1 | 3 | 1 | 3 | 1 | 3 |

TABLE 2
Geometry partitioning modes in the second
geometry partitioning mode set

| ibc_gpm_partition_idx | 0 | 1 | 2 | 3 | 4 | 5 | 6 | 7 | 8 | 9 |
|---|---|---|---|---|---|---|---|---|---|---|
| angleIdx | 2 | 2 | 2 | 3 | 3 | 3 | 4 | 4 | 4 | 5 |
| distanceIdx | 0 | 1 | 3 | 0 | 1 | 3 | 0 | 1 | 3 | 0 |
| ibc_gpm_partition_idx | 10 | 11 | 12 | 13 | 14 | 15 | 16 | 17 | 18 | 19 |
| angleIdx | 5 | 5 | 11 | 11 | 11 | 12 | 12 | 12 | 13 | 13 |
| distanceIdx | 1 | 3 | 0 | 1 | 3 | 0 | 1 | 3 | 0 | 1 |
| ibc_gpm_partition_idx | 20 | 21 | 22 | 23 | 24 | 25 | 26 | 27 | 28 | 29 |
| angleIdx | 13 | 14 | 14 | 14 | 18 | 18 | 19 | 19 | 20 | 20 |
| distanceIdx | 3 | 0 | 1 | 3 | 1 | 3 | 1 | 3 | 1 | 3 |
| ibc_gpm_partition_idx | 30 | 31 | 32 | 33 | 34 | 35 | 36 | 37 | 38 | 39 |
| angleIdx | 21 | 21 | 27 | 27 | 28 | 28 | 29 | 29 | 30 | 30 |
| distanceIdx | 1 | 3 | 1 | 3 | 1 | 3 | 1 | 3 | 1 | 3 |

When IBC-GPM is used, an IBC-GPM geometry partitioning mode set flag is signalled to indicate whether the first or the second geometry partitioning mode set is selected, followed by the geometry partitioning mode index. An IBC-GPM intra flag is signalled to indicate whether intra prediction is used for the first sub-partition. When intra prediction is used for a sub-partition, an intra prediction mode index is signalled. When IBC is used for a sub-partition, a merge index is signalled.

In some embodiments, intra block copy with local illumination compensation (IBC-LIC) is a coding tool which compensates the local illumination variation within a picture between the CU coded with IBC and its prediction block with a linear equation. The parameters of the linear equation can be derived by the reference template. IBC-LIC can be applied to IBC AMVP mode and IBC merge mode. For IBC AMVP mode, an IBC-LIC flag can be signalled to indicate the use of IBC-LIC. For IBC merge mode, the IBC-LIC flag can be inferred from the merge candidate.

Additionally, in some embodiments, a filtered IBC mode can be used. In the filtered IBC mode, a filter can be applied to IBC predictor, which is derived by minimizing MSE between current and reference template.

In some embodiments, the output of the filter can be calculated based on the following equation:

$$predLunaVal = c 0 C + c 1 N + c 2 S + c 3 E + c 4 W + c 5 P + c 6 B \qquad ( Equation 4 )$$

The nonlinear term P is represented as power of two of the center sample C and scaled to the sample value range of the content, as shown in the following equation:

$$P = ( C * C + midVal ) ≫ bitDepth \qquad ( Equation 5 )$$

In some embodiments, the bias term B represents a scalar offset between the input and output and is set to middle luma value (e.g., 512 for 10-bit content).

This filtered mode can be used as an additional mode for non-merge IBC blocks, and it is not used together with IBC-LIC, IBC-CIIP or RR-IBC. For IBC merge modes, this filtering mode can be inherited when merge mode list is constructed. The mode flag is signalled before the IBC-LIC flag.

In some embodiments, BI-IBC can be used. BI-IBC uses two block vectors to predict the current block and blends their predictions together to obtain the final prediction of the current block. ECM offers two BI-IBC methods, IBC-BVP-merge and Bi-predictive IBC merge. In the first method, IBC-BVP-merge derives the first BV from IBC block vector prediction (BVP) and the second BV from IBC merge to form bi-prediction for IBC. In some embodiments, two different indices for the IBC BVP and the IBC merge candidates are signalled. In the second method, Bi-predictive IBC merge is enabled together with MBVD and uni-merge. In bi-predictive IBC merge, two BVs from the existing IBC merge candidate list are derived, utilizing two different indices, which are signalled. Bi-predictive IBC merge can be applied to IBC regular merge and IBC MBVD.

Intra template matching prediction (Intra TMP) is a special intra prediction mode that copies the best prediction block from the reconstructed part of the current frame, whose L-shaped template matches the current template. In other words, the block vector of the current block is derived by the template in both the encoder side and the decoder side instead of signaling. For a predefined search range, the encoder searches for the most similar template to the current template in a reconstructed part of the current frame and uses the corresponding block as a prediction block. The vector which can represent the position of the matched block is stored as the block vector of the current block. The encoder then signals the usage of this mode, and the same prediction operation can be performed at the decoder side. In some embodiments, the prediction signal is generated by matching the L-shaped causal neighbor of the current block with another block in a predefined search area.

In some embodiments, the sum of absolute differences (SAD) is used as a cost function. Within each region, the decoder searches for the template that has the least SAD with respect to the current one and uses its corresponding block as a prediction block. A block vector is stored for the current block.

Consistent with the disclosed embodiments, a multi-candidate Intra TMP can be used. Intra TMP selects one matching block with the smallest template matching cost (e.g., SAD value). However, in many cases, there are several blocks that are similar to the current block, with template matching costs that are close in value. In some embodiments, a multi-candidate Intra TMP method is proposed to use multiple candidates for Intra TMP. The multi-candidate Intra TMP constructs a candidate list and ranks the candidate matching blocks in ascending order of their template matching costs, and an index can be signaled in the bitstream to indicate which candidate is actually used for current block.

In the Intra TMP fusion mode, N candidate matching blocks corresponding to the N smallest template matching costs are fused to get the final prediction block of Intra TMP. In some embodiments, an index is signalled to indicate the candidate set used for Intra TMP fusion. For example, the best 15 block vectors obtained by template matching are donated as BV0 to BV14. The index is used to indicate which one of the three candidate sets {BV0 to BV4}, {BV5 to BV9}, {BV10 to BV14} is used for fusion. In some embodiments, SAD based weight derivation method and the Wiener-filter based weight derivation method are the two methods to derive the weight in fusion, and a flag can be signaled to indicate which method is used.

In the Intra TMP filter mode, the linear filter model is applied to the prediction of Intra TMP. For example, a 6-tap linear filter includes 5 spatial luma samples in the matching block and a bias term. Filter coefficients can be derived for each block using the regression based the minimized MSE on samples between the matching template and current template.

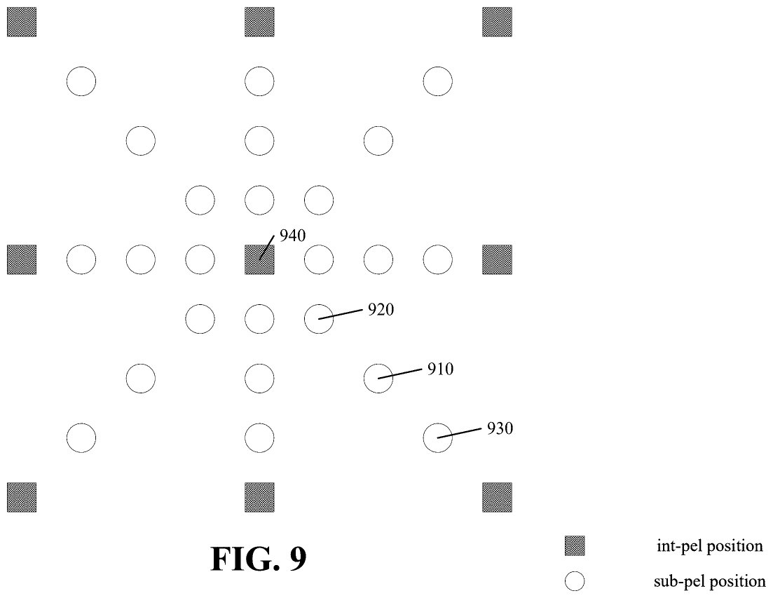

FIG. 9 is a schematic diagram illustrating sub-pel positions used for an Intra Template Matching Prediction (Intra TMP) sub-pel mode, according to some embodiments of the present disclosure. As shown in FIG. 9, in Intra TMP with sub-pel mode, three sub-pel positions 910, 920, 930, including half-pel, quarter-pel and three quarter-pel, with eight directions around the integer-pel positions 940 are supported as shown in FIG. 9. A position index is signaled to indicate which of the three sub-pel positions 910, 920, 930 is used and a direction index is signaled to indicate which of the directions is used. In some embodiments, four-tap DCT-IF interpolation filters are used for sub-pel interpolation in Intra TMP.

Further, a template-based method can be used to select fractional precisions for intra TMP. A new candidate list is constructed by including the selected integer block vector and surrounding ½-pel and 1-4-pel sub-pel positions. The list is sorted based on the same cost function used for the integer BV search. After that, the first two candidates are allowed to be selected with one single flag being signaled from encoder to decoder.

In some embodiments, IntraTMP with local illumination compensation (LIC) is permitted, similar to IBC-LIC. In some embodiments, the following considerations are taken. First, usages of intra TMP LIC and intra TMP filter are mutually exclusive for a given CU. Second, usages of intra TMP LIC together with intra TMP fusion is allowed. Third, top-only and left-only template usage for intra TMP LIC model determination is allowed for screen content coding. For camera-captured coding, only the top-left template is employed. Fourth, Multi Mode Linear Model (MMLM) is supported similarly to IBC-LIC, for screen content coding. When LIC is used for a given CU, the Intra TMP search process employs MRSAD rather than SAD distortion function.

Next, intra prediction modes used in video coding are described. The intra prediction modes can be categorized into luma intra prediction modes and chroma intra prediction modes.

First, luma intra prediction modes are described. According to the VVC standard, the luma component can be predicted by multiple intra prediction modes. These include planar mode, DC mode, angular mode, Multiple Reference Line (“MRL”) prediction mode, Intra Sub-partition (“ISP”) mode, and Matrix-based Intra Prediction (“MIP”) mode.

In the Enhanced Compression Model (ECM), several video compression technologies beyond VVC are being explored. In ECM, some intra prediction modes are extended (such as planar mode, MRL mode) and some new intra prediction modes are added (such as DIMD mode, TIMD mode, EIP mode, PDP mode and SGPM mode).

The planar mode, DC mode and angular modes are referred to as conventional intra prediction modes in the present disclosure. These modes are described in further detail below.

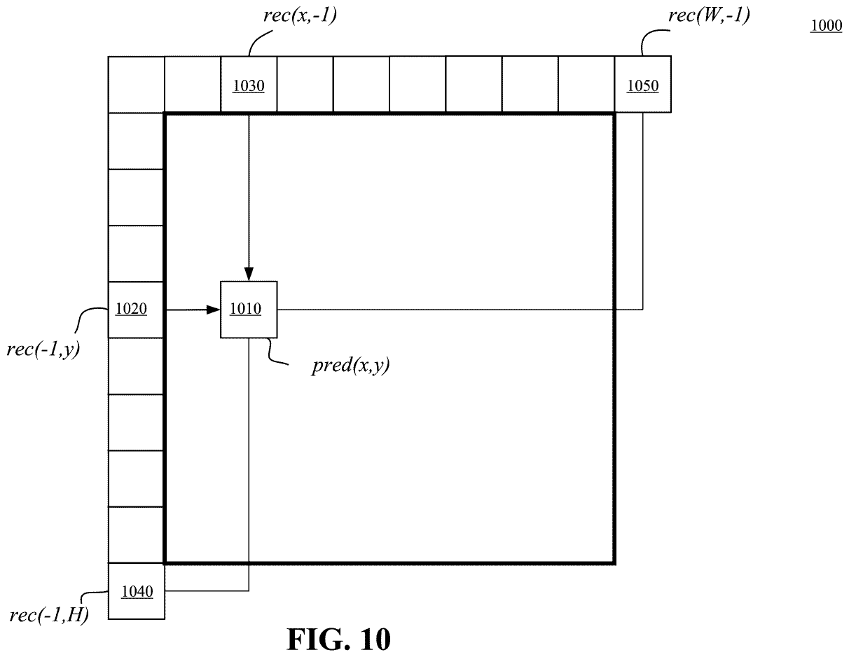

FIG. 10 is a schematic diagram illustrating exemplary reference samples used in a planar mode, according to some embodiments of the present disclosure. In the planar mode, the predicted value of the current sample 1010 in the current block 1000 is obtained from the reconstructed values of 4 reference samples, which are the left reference sample 1020 in the same row as the current sample, the above reference sample 1030 in the same column as the current sample, the reference sample 1040 on the bottom-left position adjacent to the current block and the reference sample 1050 on the top-right position adjacent to the current block. For example, using pred (x, y) to represent the predicted value of the current sample 1010, using H to represent the height of the current block 1000, and using W to represent the width of the current block 1000, then the reconstructed values of the four reference samples used in planar mode can be respectively represented as rec (−1, y), rec (x, −1), rec (−1, H) and rec (W, −1), which are shown in FIG. 10, where (x, y) represents the coordinate positions of the current sample 1010 relative to the top-left position within the current block 1000.

The planar mode generates the predicted value of the current sample according to Equations 6-8 below. Based on Equation 6, an intermediate value predV(x, y) can be obtained from rec (x, −1) and rec (−1, H). Based on Equation 7, another intermediate value predH(x, y) can be obtained from rec (−1, y) and rec (W, −1). Finally, the two intermediate values can be used to generate the predicted value of the current sample according to Equation 8.

$$predV ( x , y ) = ( ( H - 1 - y ) * rec ( x , - 1 ) + ( y + 1 ) * rec ( - 1 , H ) ) ≪ {log}_{2} W \qquad ( Equation 6 )$$

$$predH ( x , y ) = ( ( W - 1 - x ) * rec ( - 1 , y ) + ( x + 1 ) * rec ( W , - 1 ) ) ≪ {log}_{2} H \qquad ( Equation 7 )$$

$$pred ( x , y ) = ( predV ( x , y ) + predH ( x , y ) + W * H ) ≫ ( {log}_{2} W + {log}_{2} H + 1 ) \qquad ( Equation 8 )$$

In EMC, two additional planar modes where only the horizontal interpolation or only the vertical interpolation are used to obtain the predicted samples for luma. For planar horizontal mode, only the horizontal linear interpolation is performed based on the left reference sample and the top-right reference sample to predict the current sample according to Equation 9.

$$pred ( x , y ) = ( ( W - 1 - x ) * rec ( - 1 , y ) + ( x + 1 ) * rec ( W , - 1 ) + ( W ≫ 1 ) ) ) ≫ {log}_{2} ( W ) \qquad ( Equation 9 )$$

For planar vertical mode, only the vertical linear interpolation is performed based on the above reference sample and the bottom-left reference sample to predict the current sample according to Equation 10.

$$pred ( x , y ) = ( ( H - 1 - x ) * rec ( x , - 1 ) + ( y + 1 ) * rec ( - 1 , H ) + ( H ≫ 1 ) ) ≫ {log}_{2} ( H ) \qquad ( Equation 10 )$$

In the DC mode, an average value of the left and above reference samples to the current block is used for prediction generation. In HEVC, every intra-coded block has a square shape and the length of each of its side (i.e. left and above) is a power of 2. Thus, no division operations are required to calculate the average value. In VVC, blocks can have a rectangular shape that necessitates the use of a division operation per block in the general case. To avoid division operations for DC prediction, only the longer side is used to compute the average value for non-square blocks. For square blocks, reference samples from both left and above sides are used to compute the average value.

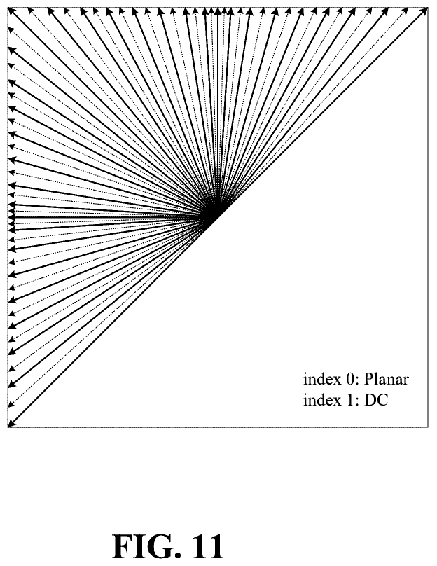

FIG. 11 is a schematic diagram illustrating angular intra prediction modes used for video coding, according to some embodiments of the present disclosure. Angular intra prediction is a directional intra prediction method, which is extended from a prior implementation according to the HEVC standard. To capture the arbitrary edge directions presented in natural video, the VVC standard extends the number of angular intra prediction modes from 33 (as used in HEVC) to 65. FIG. 11 illustrates angular intra prediction modes according to the VVC standard. The modes added in VVC are illustrated in dotted lines. The 65 angle modes can be represented as index 2 to index 66 from bottom left to top right.

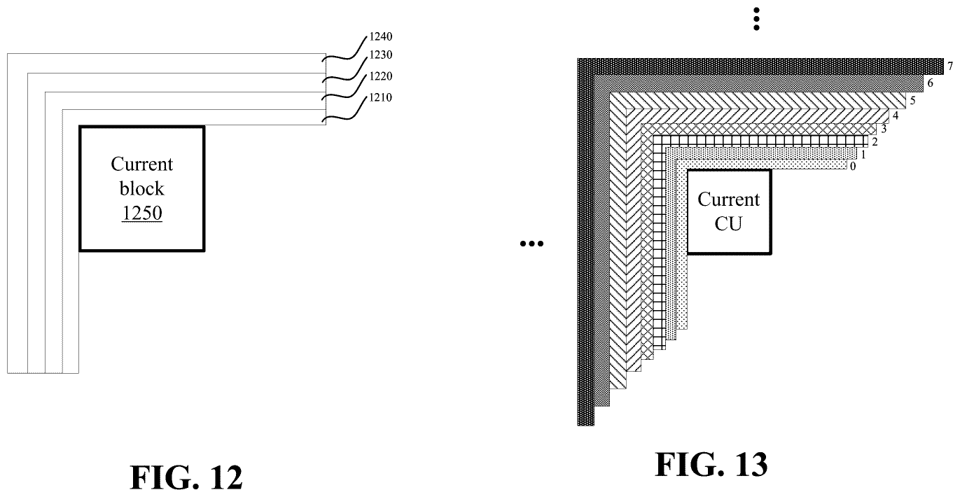

FIG. 12 is a schematic diagram illustrating a multiple reference line (MRL) intra prediction mode 1200 in which four reference lines 1210-1240 neighboring to a prediction block 1250 are used, according to some embodiments of the present disclosure. In some embodiments, MRL intra prediction uses more reference lines 1210-1240 for intra prediction. In MRL, 2 additional lines (e.g., reference line 1220 and reference line 1240) can be used. The index of selected reference line can be signalled and used to generate intra prediction samples.

FIG. 13 is a schematic diagram illustrating extended MRL candidate list used in an MRL intra prediction mode 1300, according to some embodiments of the present disclosure. In ECM, MRL list can be extended to include more reference lines for intra prediction. The extended reference line list includes line indices {1, 3, 5, 7, 12} as shown FIG. 13. For template-based intra mode derivation (TIMD), instead of the full MRL candidate list, only the first two reference line candidates, i.e., {1, 3}, are used.

In ECM, a template-based multiple reference line intra prediction (TMRL) mode combines reference line and prediction mode together and uses a template matching method to construct a list of candidate combinations. An index to the candidate combination list is coded to indicate which reference line and prediction mode is used in coding the current block. The regular multiple reference line (MRL) for the non-TIMD part is replaced by TMRL mode.

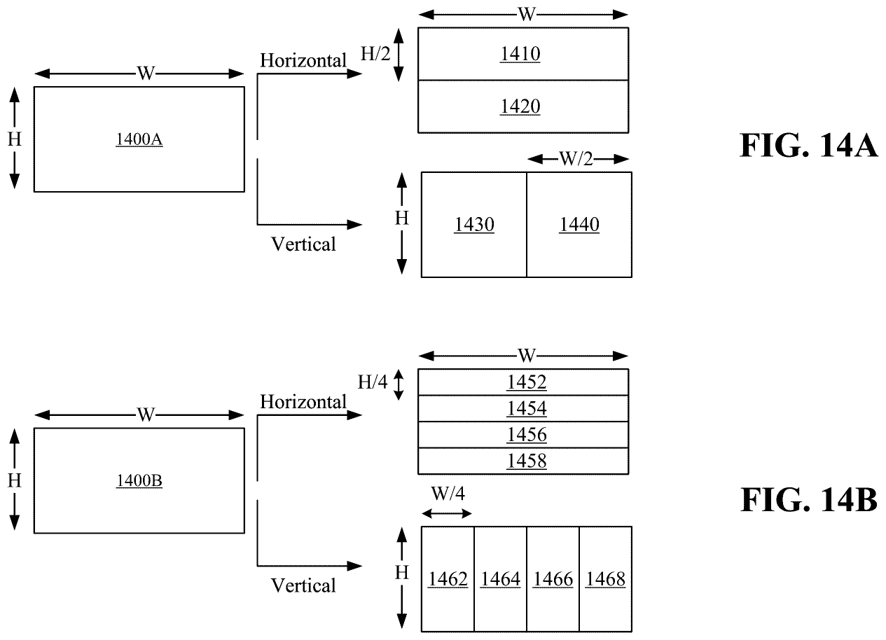

The intra sub-partitions (ISP) divides luma intra-predicted blocks vertically or horizontally into 2 or 4 sub-partitions depending on the block size as shown in FIG. 14A and FIG. 14B. FIG. 14A is a schematic diagram illustrating an example of intra sub-partitions (ISP) depending on the block size in which the sub-partitions (e.g., sub-partitions 1410, 1420 and sub-partitions 1430, 1440) are performed for 4×8 and 8×4 CUs 1400A, according to some embodiments. FIG. 14B is a schematic diagram illustrating an example of intra sub-partitions (ISP) depending on the block size in which the sub-partitions (e.g., sub-partitions 1452-1458 and sub-partitions 1462-1468) are performed for CUs 1400B other than 4×8, 8×4 and 4×4, according to some embodiments. For each sub-partition, reconstructed samples are obtained by adding the residual signal to the prediction signal. Here, a residual signal is generated by the processes such as entropy decoding, inverse quantization and inverse transformation. Therefore, the reconstructed sample values of each sub-partition are available to generate the prediction of the next sub-partition, and each sub-partition is processed repeatedly. In addition, the first sub-partition (e.g., sub-partition 1410, 1430, 1452 or 1462) to be processed is the one containing the top-left sample of the CU and then continuing downwards (horizontal split) or rightwards (vertical split). As a result, reference samples used to generate the sub-partitions prediction signals are only located at the left and above sides of the lines.

In the ISP mode, all 67 intra prediction modes (e.g., planar mode, DC mode and 65 angular modes) are allowed. All sub-partitions in a block share the same intra prediction mode. In MIP method, for predicting the samples of a block of width W and height H, MIP takes one line of H reconstructed neighboring boundary samples left of the block and one line of W reconstructed neighboring boundary samples above the block as input.

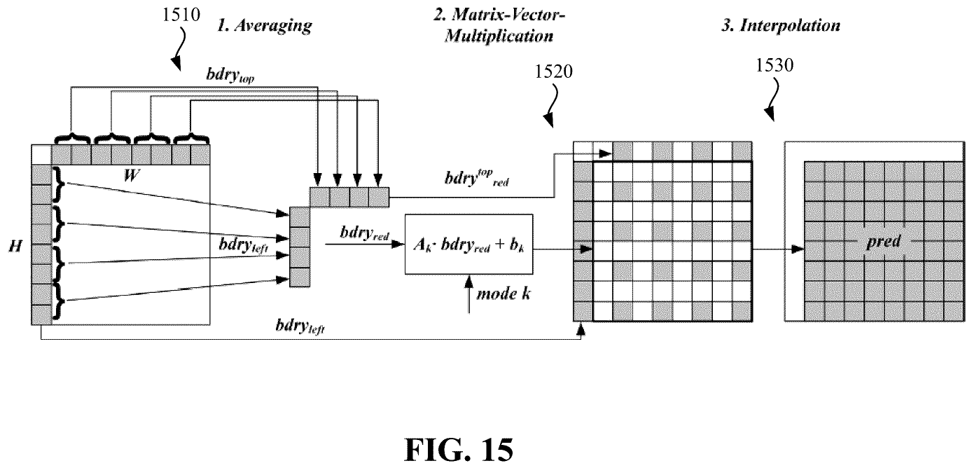

FIG. 15 is a schematic diagram illustrating an exemplary matrix weighted intra prediction process 1500, according to some embodiments of the present disclosure. The generation of the prediction signal is based on the following three steps 1510-1530. At step 1510, a down-sampling of the reference samples (e.g., bdryₜₒₚ for the top boundary and bdry_{left} for the left boundary) is performed by averaging the reference samples. At step 1520, a matrix vector multiplication is performed. At step 1530, a linear interpolation is performed to up-sample the result, as shown in FIG. 15.

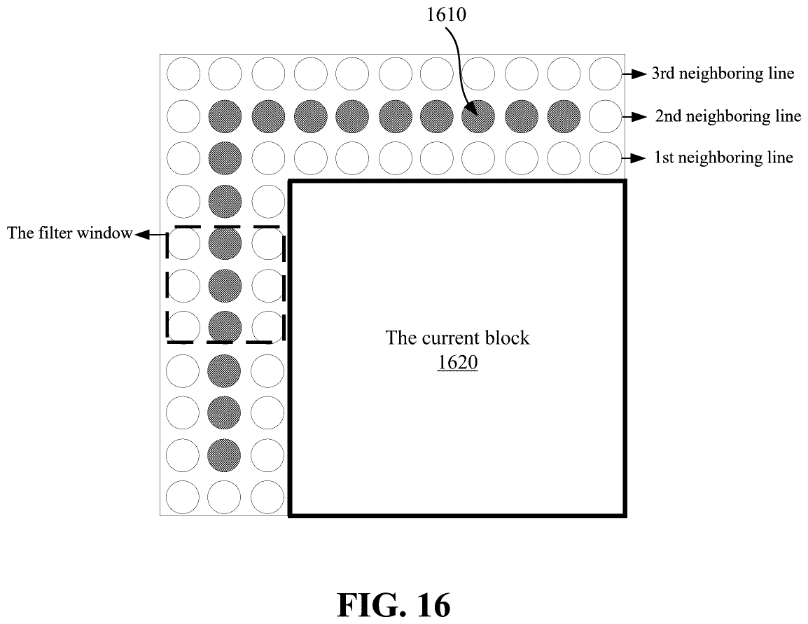

FIG. 16 is a schematic diagram illustrating exemplary samples used for calculating gradients in a decoder side intra mode derivation (DIMD) mode, according to some embodiments of the present disclosure. In ECM, a decoder side intra mode derivation (DIMD) mode can be applied. Up to five intra modes are derived from the reconstructed neighbor samples, and those five predictors are combined with the non-directional predictor (planar or BV based predictor) with the weights derived from the histogram of gradients.

To build the DIMD histogram for a block, a gradient analysis is performed on the samples 1610 of L-shaped template of the second neighboring line surrounding the block 1620. The samples 1610 are depicted as grey circles in FIG. 16. For each available reconstructed pixel of the template, a horizontal gradient and a vertical gradient, Gx and Gy, are carried out by applying horizontal and vertical Sobel filters based on the following equation:

$${F}_{h o r} = [ \begin{matrix}1 & 0 & - 1 \\ 2 & 0 & - 2 \\ 1 & 0 & - 1\end{matrix} ] and {F}_{v e r} = [ \begin{matrix}- 1 & - 2 & - 1 \\ 0 & 0 & 0 \\ 1 & 2 & 1\end{matrix} ] \qquad ( Equation 11 )$$

For each sample in the template, for which the horizontal gradient Gx and the vertical gradient Gy are calculated, the intensity (G) and the orientation (O) of the gradients are further calculated using Gx and Gy based on the following equation:

$$G = \vert {G}_{x} \vert + \vert {G}_{y} \vert and O = atan ( \frac{{G}_{y}}{{G}_{x}} ) \qquad ( Equation 12 )$$

The orientation of the gradients O is then converted into the closest intra angular prediction mode, used to index a histogram which is first initialized to zero. And the histogram value at that intra angular prediction mode is increased by G. Once all the samples in the template have been processed, the histogram will contain cumulative values of gradient intensities, for each intra angular prediction mode. Up to five angular modes with the highest and second highest amplitude values will be selected and are used for the following prediction fusion process. If the maximum amplitude value in the histogram is 0, then the PLANAR mode is selected as intra prediction mode for the current block.

The decision between for the non-directional modes is taken according to the template cost. Specifically, the block vectors of all adjacent and non-adjacent merge candidates (coded in IntraTMP or IBC) are compared to planar prediction on the reconstructed template. The template cost (SATD) is used to select the best predictor among them.

For a block of size W×H, the weight for each of the five derived modes is modified if the one the above or left histogram magnitudes is twice larger than the other one. In this case, the weights are location dependent and computed based on the following equations. If the above histogram is twice the left, then the weights are computed based on the following Equation 13:

$${w}_{i} ( x , y ) = {wDimd}_{i} + {Δ}_{i} - 2 {Δ}_{i} \frac{y}{( H - 1 )} . \qquad ( Equation 13 )$$

If the left histogram is twice the above, then the weights are computed based on the following Equation 14:

$${w}_{i} ( x , y ) = {wDimd}_{i} + {Δ}_{i} - 2 {Δ}_{i} \frac{x}{( W - 1 )} , \qquad ( Equation 14 )$$

where wDimdᵢ is the unmodified uniform weight of the DIMD, Δᵢ is pre-defined and set to 10.

Derived intra modes are included into the primary list of intra most probable modes (MPM), so the DIMD process is performed before the MPM list is constructed. The primary derived intra mode of a DIMD block is stored with a block and is used for MPM list construction of the neighboring blocks.

An occurrence-based intra coding (OBIC), derives the intra prediction modes of the current block based on the sample-wise occurrence of the intra modes in the spatial neighborhood of the block. For this, adjacent and non-adjacent spatial neighboring blocks are checked and the intra prediction modes of the blocks are collected into an occurrence histogram. Instead of Histogram of Gradients (HoGs) as in DIMD, the OBIC method uses the Histogram of Occurrences, which consists of the intra modes and their sample-wise occurrences. The occurrence values are calculated based on the number of samples that are coded in a certain intra prediction mode in that neighborhood. For example, if a uiWidth×uiHeight block is coded with an IPM mode, the occurrence of the mode in that block is calculated based on the following Equation 15:

$$Histogram [ IPM ] += uiWidth \times uiHeight ; \qquad ( Equation 15 )$$

where uiWidth and uiHeight are the width and height of a spatial neighboring block. The occurrences of the existing modes from the spatial neighborhood blocks are accumulated into the histogram.

Up to five angular modes with the highest occurrence along with the planar mode or block vector-based prediction (same as in DIMD) are selected from the histogram and used for final prediction by blending the prediction of the selected modes.

For each intra prediction mode in MPMs, as well as the wide-angle modes if the above-right and/or bottom-left reference samples are available, SATD between the prediction and reconstruction samples of the template is calculated. First two intra prediction modes with the minimum SATD and one non-angular intra prediction mode (i.e., DC or Planar) with the lowest SATD cost are selected as the TIMD modes. These three TIMD modes are fused with the weights after applying PDPC process, and such weighted intra prediction is used to code the current CU. Position dependent intra prediction combination (PDPC) is included in the derivation of the TIMD modes.

The conditions below are checked to determine whether the non-angular intra prediction mode is used in fusion: (1) the non-angular intra prediction mode is different from the two selected intra prediction modes; (2) costMode3<1.5*costMode1, where the costMode3 is the SATD cost of the non-angular intra prediction mode and costMode1 is the SATD cost of the first intra prediction mode.

If both of the above conditions are true, three intra prediction modes are used to generate the prediction, and the weights of each intra prediction mode are computed from SATD cost based on the following equation:

$${weight}_{i} = \frac{sumSATD - {costMode}_{i}}{2 \times sumSATD} , sumSATD = {\sum }_{j = 1}^{3} {costMode}_{i} . \qquad ( Equation 16 )$$

Otherwise, the non-angular intra prediction mode is not used in prediction. And the costs of the two selected modes are compared with a threshold, in the test the cost factor of 2 is applied based on the following equation:

$$costMode 2 < 2 * costMode 1. \qquad ( Equation 17 )$$

If this condition is true, the fusion is applied, otherwise the only mode 1 is used. Weights of the modes are computed from their SATD costs based on the following equations:

$$weight 1 = costMode 2 / ( costMode 1 + costMode 2 ) \qquad ( Equation 18 )$$

$$weight 2 = 1 - weight 1$$

Moreover, location-dependent sample-based fusion used in DIMD fusion process is used for the TIMD fusion but the location-dependent criterion applying to amplitudes of the selected predictors is replaced by a SATD cost-based criteria. The location-dependent criterion is determined from a ratio of the normalized SATD of the selected TIMD predictors computed in above and left template area.

In ECM, an intra fusion method can be used for intra prediction. This intra prediction method derives predicted samples as a weighted combination of multiple predictors generated from different reference lines. In this process, multiple intra predictors are generated and then fused by weighted averaging. The process of deriving the predictors to be used in the fusion process is described as follows.

First, for angular intra prediction modes including the single mode case of TIMD and DIMD, the proposed method derives intra prediction by weighting intra predictions obtained from multiple reference lines represented as p_{fusion}=w₀pₗᵢₙₑ+w₁pₗᵢₙₑ₊₁, where pₗᵢₙₑ is the intra prediction from the default reference line and pₗᵢₙₑ₊₁ is the prediction from the line above the default reference line. The weights are set as w₀=¾ and w₁=¼.

For TIMD mode with blending, pₗᵢₙₑ is used for the first mode (w₀=1, w₁=0) and pₗᵢₙₑ₊₁ is used for the second mode (w₀=0, w₁=1).

For DIMD mode with blending, the number of predictors selected for a weighted average is increased from 3 to 6.

The angular intra prediction fusion method is applied to luma blocks when angular intra mode has non-integer slope (required reference samples interpolation) and the block size is greater than 16, it is used with MRL and not applied for ISP coded blocks. In the method studied in the sub-test a, PDPC is applied for the intra prediction mode using the closest to the current block reference line.

The TIMD mode with blending method is applied when all the following three conditions are satisfied. First, both the first and second modes are angular prediction mode. Second, the current block is not ISP coded block. Third, all of the following conditions are false: (1) abs(predModeIntra1-predModeIntra2) is greater than a threshold value, which is set to 8 or 4 depending on block size; (2) (predModeIntra1−EXT_HOR_IDX)*(predModeIntra2−EXT_HOR_IDX) is less than 0; and (3) (predModeIntra1−EXT_VER_IDX)*(predModeIntra2−EXT_VER_IDX) is less than 0.

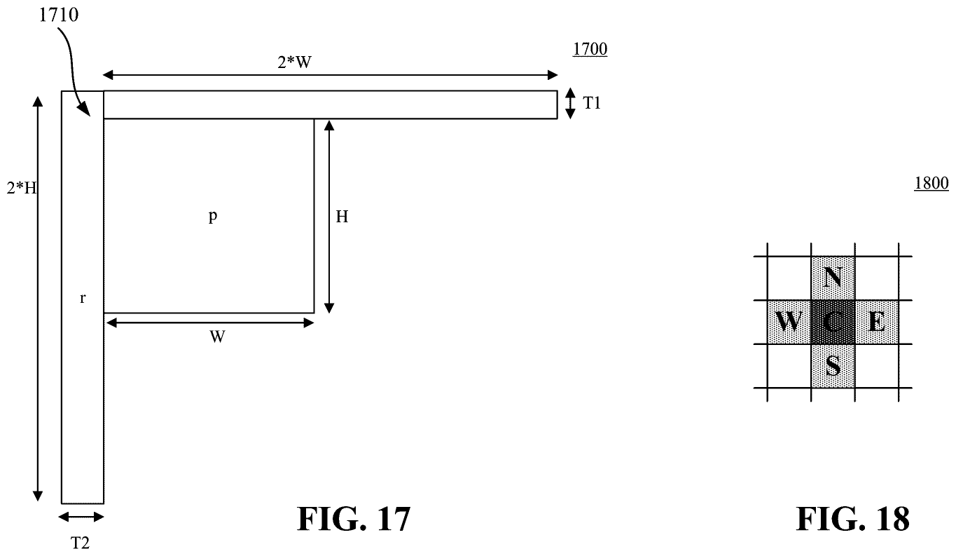

In some embodiments, a MIP replacement method can be used in ECM. A matrix of weights, which are defined for a block shape and intra mode, is introduced, those weights are multiplied by the neighbor reference template to derive the prediction samples replacing conventional intra prediction. FIG. 17 is a schematic diagram illustrating L shaped neighborhood for a given predicted block, according to some embodiments of the present disclosure. The weights are applied to the reference samples of the L shaped causal neighborhood template as shown in FIG. 17.

For example, the reference samples 1710 in the causal neighborhood are denoted as r, and F(x,y) is the matrix of weights. Then the prediction P(x,y) can be derived based on the following equation:

$$P ( x , y ) = {\sum }_{k} F ( x , y , k ) * r ( k ) ,$$

where k denotes the index of the reference sample in the template.

This prediction is used for block size with both width and height up to 32 (except for 4×32, 32×4, 8×32 and 32×8). In some embodiments, the template size is 2 for blocks with both width and height up to 16 and it is only used for modes with indexes 0, 1, and (2+2*k). For other blocks, template size is set to 1 and is used for modes with indexes 0, 1, and (2+4*k). The prediction is only performed for 16×16 positions, and the rest of the samples can be generated by bilinear interpolation. For all block sizes, block shape and mode-based symmetry is used. Reference length is set to W and H for modes greater than 18 and less than 50 and set to 2*W and 2*H otherwise.

In some embodiments, an extrapolation filter-based intra prediction (EIP) mode is used in ECM. In the EIP mode, the samples in a CU are predicted from the top-left position to the bottom-right position by applying an extrapolation filter to neighboring reconstructed samples or predicted samples. The EIP mode uses a 15-tap filter for prediction based on the following equation:

$${pred}_{( x , y )} = {\sum }_{i = 0}^{13} ( {c}_{i} \times {t}_{( x - {offsetX}_{i} , y - {offsetY}_{i} )} ) + {c}_{14} \times {2}^{bitdepth - 1} , \qquad ( Equation 19 )$$

where pred_{(x,y)} is the predicted value at position (x, y) in the CU, cᵢ is the filter coefficient, and the t_{(x-offsetX}_{ᵢ}_{,y-offsetY}_{ᵢ}₎ is the reconstructed samples or predicted samples. Predicted sample values are clipped to the range of the reference samples instead of the full sample value range. Reference sample area used for determining the range is the same that is used when generating the filter coefficients.

The EIP filter can be derived from the neighboring reconstructed samples or be inherited from the previous EIP coded blocks.

Spatial Geometric partitioning mode (SGPM) is an intra mode that resembles the inter coding tool of GPM, where the two prediction parts are generated from intra predicted process. In this mode, a candidate list is built with each entry containing one partition split and two intra prediction modes. 26 partition modes and 9 of intra prediction modes are used to form the combinations. In some embodiments, the length of the candidate list is set equal to 16. The selected candidate index can be signalled.

For VVC, the intra prediction modes available for the chroma components include the Cross Component Linear Model (CCLM) mode, the Direct Mode (DM), and four default intra prediction modes. In ECM, some chroma intra prediction modes (e.g., CCLM mode) are extended and some new intra prediction modes (e.g., chroma DIMD mode and chroma fusion mode) are added.

VVC adopts the Cross Component Linear Model (CCLM) using a linear model to represent the relationship between luma and chroma component. In this model, a chroma sample of a block can be predicted from the collocated reconstructed luma sample by a linear model based on the following equation:

$${pred}_{C} ( i , j ) = α \cdot {rec}_{L}^{′} ( i , j ) + β \qquad ( Equation 20 )$$

where pred_{C}(i, j) represents the predicted values of the chroma samples in the current block and rec′_{L}(i, j) represents the reconstructed values of the collocated luma samples of the same block which are down-sampled for the case of non-4:4:4 color format. (i, j) is the coordinate of a sample in the block. Parameters α and β can represent a linear model and the values of the two parameters are derived based on reconstructed samples that are adjacent to the current block at both encoder and decoder side without explicit signaling.

VVC specifies three CCLM modes, CCLM_LT, CCLM_L and CCLM_T. These three modes differ with respect to the locations of the reconstructed adjacent samples that are used for linear model parameters (α and β) derivation. The above reconstructed adjacent samples are involved in the CCLM_T mode, and the left reconstructed adjacent samples are involved in the CCLM_L mode. In the CCLM_LT mode, both above and left reconstructed adjacent samples are used.

In ECM, CCLM included in VVC is extended by adding three Multi-model LM (MMLM) modes. In each MMLM mode, the samples within a CU are divided into different groups and each group has a liner model for prediction. Dependent on the adjacent reconstructed samples used in model derivation, multi-model CCLM also have different modes: MMLM_LT, MMLM_L and MMLM_T. The difference among the three modes is the same as the difference among CCLM_LT, CCLM_L and CCLM_T modes, referring to the locations of the reconstructed adjacent samples used for linear model parameters (a and B) derivation. In each MMLM mode, there can be more than one linear model between luma and chroma in a block. First, the reconstructed adjacent samples are classified into two classes using a threshold, which is the average of the values of the luma reconstructed adjacent samples. Then, each class is treated as an independent training set to derive a linear model, using the aforementioned LMMSE method. Subsequently, the reconstructed luma samples of the current block are also classified based on the same rule. Finally, the chroma samples can be predicted by the reconstructed luma samples differently in different classes.

In ECM, a convolutional cross-component model (CCCM) can be applied to predict chroma samples from reconstructed luma samples in a similar spirit as done by the CCLM modes. As with CCLM, the reconstructed luma samples are downsampled to match the lower resolution chroma grid when chroma sub-sampling is used. Similar to CCLM, top, left or top and left adjacent samples are used as templates for model derivation. Also, similar to CCLM, it is an option to use a single model or multi-model variant of CCCM.

FIG. 18 is a schematic diagram illustrating spatial part of a convolutional filter 1800, according to some embodiments of the present disclosure. The convolutional 7-tap filter includes a 5-tap plus sign shape spatial component, a nonlinear term, and a bias term. The input to the spatial 5-tap component of the filter includes a center (C) luma sample which is collocated with the chroma sample to be predicted and its above/north (N), below/south(S), left/west (W) and right/east (E) neighbors as illustrated in FIG. 18.

In ECM, several variants of CCCM mode are applied, such as CCCM with non-downsampled luma samples (NS-CCCM), Block-vector guided CCCM (BVG-CCCM), Gradient and Location based convolutional cross-component model (GL-CCCM), and CCCM with Multiple Downsampling Filters (MDF-CCCM). In ECM, a Gradient Linear Model (GLM) method is proposed. Compared with CCLM, instead of downsampling the reconstructed luma samples, the GLM can utilize luma sample gradients to derive the linear model.

All these modes, including CCLM mode, CCCM mode, GLM mode and their variants, reduce the signal redundancy between difference components and can be collectively known as cross-component prediction (CCP) modes in the present disclosure.

When the DM mode is used, the intra prediction mode of the corresponding luma block determines the chroma intra mode as follows. If the corresponding luma block uses the planar, DC or an angular mode, the same mode is used to predict the current chroma block. If the corresponding luma block is coded using IBC or Palette mode, the DC mode is used to predict the current chroma block. If the corresponding luma block is coded using BDPCM mode, depending on the direction of the BDPCM, either the horizontal or the vertical intra prediction mode is used. If the corresponding luma block uses MIP, then, if the chroma color format is 4:4:4 and the single partitioning tree is applied, the same MIP mode is applied for the chroma block and otherwise, the planar mode is applied. For B and P slice, the corresponding luma block represents the luma block at the same position as the current chroma block.

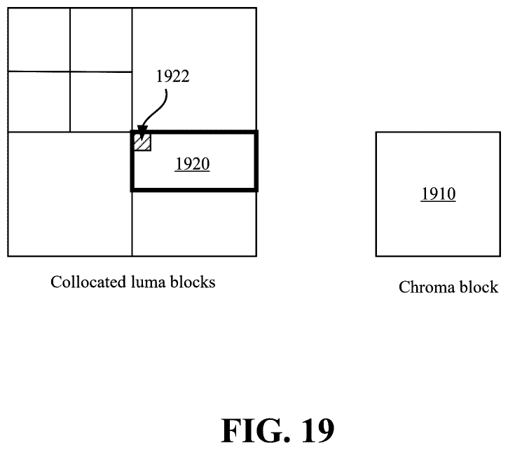

FIG. 19 is a schematic diagram illustrating corresponding luma block 1920 for direct mode (DM) mode in I Slice, according to some embodiments of the present disclosure. For I slice, one chroma coding block 1910 may correspond to multiple luma coding blocks since the separate block partitioning structure for luma and chroma components is enabled. Accordingly, the corresponding luma block 1920 represents the luma coding block containing the center position luma sample 1922 as shown in FIG. 19.

In some embodiments of the present disclosure, the luma block with the same position as the current chroma block can be denoted as the collocated luma block. For example, for 4:2:0 color format, for a W×H chroma block with position coordinate (i, j), the collocated luma block is a 2W×2H luma block at (2i, 2j).

In VVC, when the CCLM modes and DM mode are not used, the other four default modes are given by the list {planar mode, vertical mode, horizontal mode, DC mode} and can be used to predict a chroma block. In cases where the DM mode already belongs to that list, that is, the intra chroma prediction mode derived from the DM mode is the same as one of the four default modes, then the default mode in the list is replaced with an angular mode with a mode index of 66.

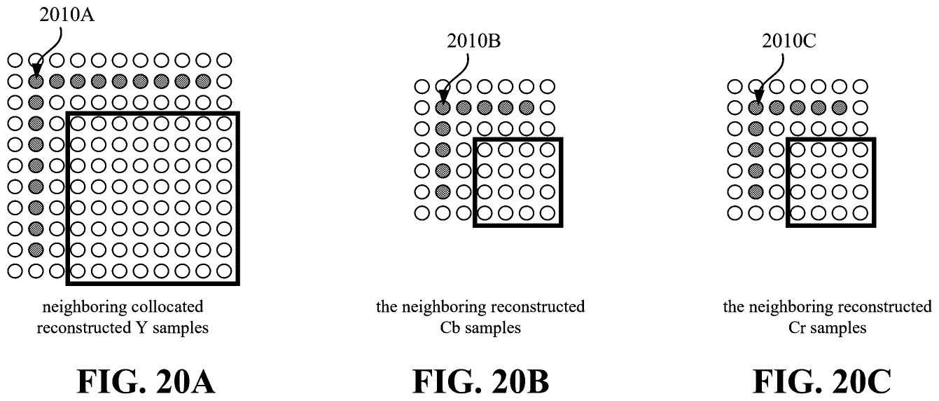

FIGS. 20A-20C are schematic diagrams illustrating neighboring reconstructed samples used for decoder side intra mode derivation (DIMD) chroma mode, according to some embodiments of the present disclosure. In ECM, a DIMD chroma mode can be used to predict a chroma block. A chroma intra prediction mode among planar mode, DC mode and the 66 angular modes can be derived based on the neighboring reconstructed Y, Cb and Cr samples 2010A, 2010B, and 2010C in the second neighboring row and column as shown in FIGS. 20A-20C. Specifically, a horizontal gradient and a vertical gradient are calculated for each collocated reconstructed luma sample of the current chroma block, as well as the reconstructed Cb and Cr samples, to build a histogram of gradients. Then the intra prediction mode with the largest histogram amplitude values is used for performing chroma intra prediction of the current chroma block.

When the intra prediction mode derived from the DIMD chroma mode is the same as the intra prediction mode derived from the DM mode, the intra prediction mode with the second largest histogram amplitude value is used as the DIMD chroma mode. A CU level flag is signaled to indicate whether the proposed DIMD chroma mode is applied.

The luma region of reconstructed samples used for computing the histogram of gradients for chroma DIMD mode is modified compared to JVET-00449. For a W×H chroma block, to build the histogram of gradients associated to the collocated luma block, the pairs of a vertical gradient and a horizontal gradient are extracted from the second and third lines in this collocated luma block instead of the second neighboring row and column of the collocated luma block.

In ECM, two chroma intra prediction signals can be fused together. One of the two chroma intra prediction signals is predicted using one of the DM mode, DIMD chroma mode, and the four default modes (which can be referred as non-CCP mode). The other chroma intra prediction signal is predicted using cross-component prediction modes (e.g., a CCP mode). In some embodiments, two different methods are supported.

In the first method, the CCP mode can be either multi-model CCLM mode or multi-model CCCM mode, and the final predictor is derived based on the following equation:

$${pred}_{C} ( i , j ) = ( w 0 \times pred 0 ( i , j ) + w 1 \times pred 1 ( i , j ) + ( 1 ≪ ( shift - 1 ) ) ) ≫ shift \qquad ( Equation 21 )$$

where pred0(i, j) is the predictor obtained by applying the non-CCP mode, pred1(i, j) is the predictor obtained by applying the CCP mode and pred_{C}(i, j) is the final predictor of the current chroma block. The two weights, w0 and w1 are determined by the intra prediction mode of adjacent chroma blocks and shift is set equal to 2. Specifically, when the above and left adjacent blocks are both coded with CCP modes, {w0, w1}={1, 3}; when the above and left adjacent blocks are both coded with non-CCP modes, {w0, w1}={3, 1}; otherwise, {w0, w1}={2, 2}. Two template costs are calculated by fusing the non-CCP chroma prediction with MM-CCLM or MM-CCCM, respectively, and the one of the two CCP modes which provides a smaller template cost is utilized to derive pred1.

In the second method, the CCP mode can be either MMLM or CCLM mode, and the final predictor is derived based on the following equation:

$${pred}_{C} ( i , j ) = {α}_{0} \times pred 0 ( i , j ) + {α}_{1} \times {rec}_{L}^{′} ( i , j ) + {α}_{2} \times β \qquad ( Equation 22 )$$

where pred0(i, j) is the predictor obtained by applying the non-CCP mode, rec′_{L}(i, j) is the set of down-sampled reconstructed luma samples at co-located positions and pred_{C}(i, j) is the final predictor of the current chroma block. β is a fixed value and is set equal to 512 for 10-bit content. The three weights, α₀, α₁ and α₂ can be derived from the adjacent luma and chroma samples using the same derivation method as in CCCM.

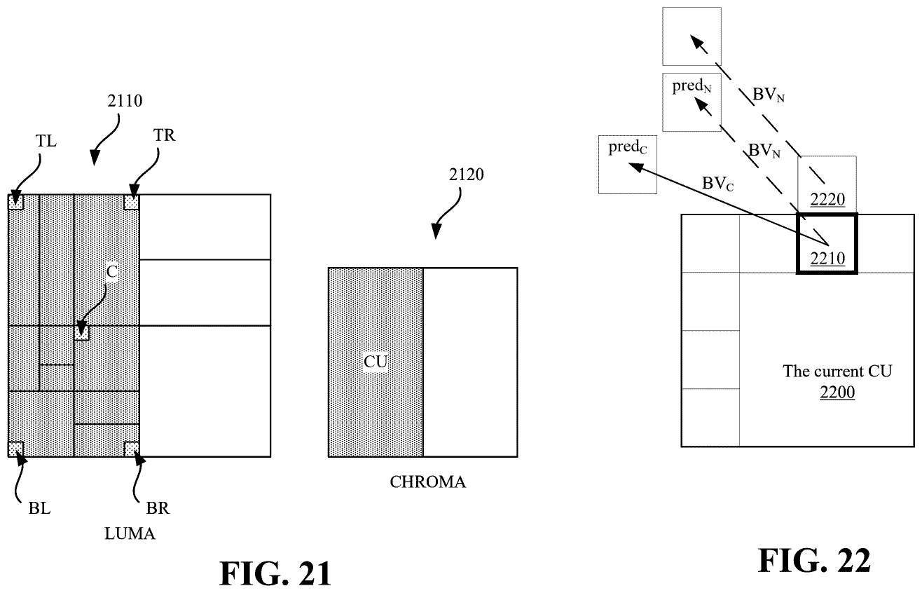

FIG. 21 is a schematic diagram illustrating luma blocks used to derive direct block vector, according to some embodiments of the present disclosure. In ECM, a chroma direct block vector (chroma DBV) mode can be used to predict a chroma block for dual tree. If at least one of the luma blocks in five locations C, TL, TR, BL, BR of the collocated luma block 2110 as shown in FIG. 21 is coded with IBC or intraTMP mode and the block vector is available for the current chroma block, its block vector is scaled and used as the block vector for the current chroma block. The block vector is selected in the following order: {C, TL, TR, BL, BR}, and the first block vector that is available for the current chroma block 2120 is selected. Then, a template matching method is used to perform block vector scaling.

If the luma block 2110 that the block vector is selected from is coded with a RRIBC mode, the flip type is inherited to the current chroma block 2120 and the flip scheme of the RRIBC is performed. That is, at the encoder side, the original block is flipped before residual calculation, while the prediction block is derived without flipping; at the decoder side, the reconstruction block is flipped back to restore the original block.

The above-described OBMC methods may present the following challenges. First, the existing OBMC is only performed for inter prediction mode coded blocks to improve coding efficiency. The existing OBMC blends different motion vectors in the boundary to solve the block artifacts, but it cannot be performed for intra TMP and IBC coded blocks using block vectors. The difference between the motion vector and the block vector is that the motion vector corresponds to a position in other frame, while the block vector corresponds to a position in the current frame. It can be assumed that block artifacts may also exist if the block vector of the current block is different from the block vector of neighboring block. Therefore, an intra OBMC method for intra TMP and IBC coded blocks is proposed in the embodiments of the present disclosure to refine the prediction signal.

In addition, existing OBMC design does not support cases where a neighbor block is an intra prediction mode coded block or a BV coded block (e.g., IBC mode or intra TMP mode). It can be assumed that, at the boundary of the two different prediction modes, artifacts may exist and should be considered in the OBMC design.

Embodiments of the present disclosure provide methods to solve one or more of the above-described problems associated with OBMC.

In some embodiments, an intra OBMC method may be applied to CUs using intra TMP mode or IBC mode. A block can be predicted using intra TMP mode or IBC mode, which means that a block vector for the block exists and corresponds to a reconstructed block in the current frame. Specifically, the proposed intra OBMC can be performed for top and left boundaries of a CU at a sub-block level. In some embodiments, the sub-block can be a 4×4 sub-block, which means both the width and height of the sub-block are 4 samples for luma component.

FIG. 22 is a schematic diagram illustrating the block vectors BV_{C}, BV_{N} and prediction signals pred_{C} and pred_{N} of a sub-block in a top boundary of a CU 2200 when intra OBMC is performed, according to some embodiments of the present disclosure.

When intra OBMC is applied to the current sub-block 2210, in addition to the current block vector BV_{C}, the block vector BV_{N}, which is from top neighboring sub-block 2220 when the current sub-block is in the top boundary (or from left neighboring sub-block when the current sub-block is in the left boundary), is also used to derive the prediction signal for the current sub-block 2210. The prediction signal pred, based on the current block vector BV_{C} and the prediction signal pred_{N} based on the neighboring block vector BV_{N} are blended to generate the final prediction signal pred for the current sub-block 2210.

In some embodiments, the prediction signal pred_{C} is obtained by performing the intra TMP mode or IBC mode of the current sub-block 2210. In this way, intra OBMC can be regarded as after the prediction signal of the current CU 2200 is obtained by using the intra TMP mode or IBC mode, the top boundary and the left boundary of the current CU 2200 are corrected by using the block vectors of the adjacent blocks at the sub-block level.

In some embodiments, for the current sub-block 2210, if the neighboring sub-block 2220 is not available (e.g., being out of the frame or slice boundary) or is predicted by an intra TMP mode or an IBC mode or does not have a valid block vector, the intra OBMC is not performed, which means the prediction signal pred_{C} is used as the final prediction signal of the current sub-block 2210.

In some embodiments, if the neighboring block vector BV_{N} is not available for the current sub-block 2210, which means the sub-block of the corresponding position obtained by using BV_{N} to the current sub-block 2210 is not available (e.g., being out of the frame or slice boundary, or not reconstructed yet), the intra OBMC is not performed.

The blending can be performed by the following Equation 23:

$$( Equation 23 )$$

$$for top boundary \{ \begin{matrix}pred ( i , 0 ) = ( w {0}_{C} * {pred}_{C} ( i , 0 ) + w {0}_{N} * {pred}_{N} ( i , 0 ) + offset 0 ) ≫ shift 0 ) , 0 \leq i < 4 \\ pred ( i , 0 ) = ( w {1}_{C} * {pred}_{C} ( i , 0 ) + w {1}_{N} * {pred}_{N} ( i , 0 ) + offset 1 ) ≫ shift 1 ) , 0 \leq i < 4 \\ pred ( i , 0 ) = ( w {2}_{C} * {pred}_{C} ( i , 0 ) + w {2}_{N} * {pred}_{N} ( i , 0 ) + offset 2 ) ≫ shift 2 ) , 0 \leq i < 4 \\ pred ( i , 0 ) = ( w {3}_{C} * {pred}_{C} ( i , 0 ) + w {3}_{N} * {pred}_{N} ( i , 0 ) + offset 3 ) ≫ shift 3 ) , 0 \leq i < 4\end{matrix}$$

$$for left boundary \{ \begin{matrix}pred ( 0 , j ) = ( w {0}_{C} * {pred}_{C} ( 0 , j ) + w {0}_{N} * {pred}_{N} ( 0 , j ) + offset 0 ) ≫ shift 0 ) , 0 \leq j < 4 \\ pred ( 1 , j ) = ( w {1}_{C} * {pred}_{C} ( 1 , j ) + w {1}_{N} * {pred}_{N} ( 1 , j ) + offset 1 ) ≫ shift 1 ) , 0 \leq j < 4 \\ pred ( 2 , j ) = ( w {2}_{C} * {pred}_{C} ( 2 , j ) + w {2}_{N} * {pred}_{N} ( 2 , j ) + offset 2 ) ≫ shift 2 ) , 0 \leq j < 4 \\ pred ( 3 , j ) = ( w {3}_{C} * {pred}_{C} ( 3 , j ) + w {3}_{N} * {pred}_{N} ( 3 , j ) + offset 3 ) ≫ shift 3 ) , 0 \leq j < 4\end{matrix}$$

where coordinates (i, j) represent the horizontal distance i and vertical distance j between the current sample and the sample in the top left corner of the current sub-block. For sub-blocks in the top boundary, the samples in the same row share the same weights; for sub-blocks in the left boundary, the samples in the same column share the same weights. In Equation 23, w0_{C} to w3_{C} are the weights for pred_{C} in each row/column, w0_{N} to w3_{N} are the weights for Pred_{N} in each row/column, which can be any integer values. In various embodiments, the weights shown in Equation 23 or in other equations above (e.g., Equation 2 and Equation 3) can be used for intra OBMC.

In some embodiments, whether to apply intra OBMC to a sub-block is determined based on the predicted value of the samples of the sub-block. For example, the maximum value of the absolute difference between pred_{C} and pred_{N}, can be used to determine whether to apply intra OBMC to a sub-block. If the value is greater than (or equal to) a threshold, the intra OBMC is not performed for the current sub-block. For another example, the absolute difference between the average value of pred_{C} and the average value of pred_{N}, can be used to determine whether to apply intra OBMC to a sub-block. If the value is greater than (or equal to) a threshold, the intra OBMC is not performed for the sub-block. For yet another example, the sum of the absolute difference (SAD) between pred_{C} and pred_{N} can be used to determine whether to apply intra OBMC to a sub-block. If the value is greater than (or equal to) a threshold, the intra OBMC is not performed for the sub-block.

In some embodiments, whether to apply intra OBMC to a sample in a sub-block is determined based on the predicted value of the sample. For example, for a sample with coordinates (i, j), the difference between pred_{C}(i, j) and pred_{N}(i, j) can be used to determine whether to apply intra OBMC to the sample. If the value is greater than (or equal to) a threshold, the pred_{C}(i, j) is used as the final prediction; otherwise, the blending of pred_{C}(i, j) and pred_{N}(i, j) is used as the final prediction.

In some embodiments, the weight used for blending in intra OBMC can be determined based on pred_{C} and pred_{N} for a sub-block. For example, the maximum value of the absolute difference between pred_{C} and pred_{N}, or the absolute difference between the average value of pred_{C} and the average value of pred_{N}, or the SAD value between pred_{C} and pred_{N} can be used to determine the weights.

In some embodiments, the maximum value of the absolute difference between pred_{C} and pred_{N} can be recorded as max and used to determine the weight use for blending for a sub-block in intra OBMC. When max is greater than a first threshold TH1, the current sub-block does not perform OBMC. When max is greater than a second threshold TH2 and less than (or equal to) the first threshold TH1, the weight corresponding to Equation 3 is used. When max is greater than a third threshold TH3 and less than (or equal to) the second threshold TH2, the weight corresponding to Equation 2 is used. When max is less than (or equal to) the third threshold TH3, the weight corresponding to Equation 1 is used. The thresholds TH1, TH2 and TH3 can be any positive integers. For example, in some embodiments, the first threshold TH1 is set to 384, the second threshold TH2 is set to 264, and the third threshold TH3 is set to 144, but the present disclosure is not limited thereto.

In some other embodiments, when max is greater than the first threshold TH1, the current sub-block does not perform OBMC. When max is greater than the second threshold TH2 and less than (or equal to) the first threshold TH1, the weight corresponding to Equation 24 is used. When max is greater than the third threshold TH3 and less than (or equal to) the second threshold TH2, the weight corresponding to Equation 3 is used. When max is greater than the fourth threshold TH4 and less than (or equal to) the third threshold TH3, the weight corresponding to Equation 2 is used. When max is less than (or equal to) the fourth threshold TH4, the weight corresponding to Equation 1 is used. The thresholds TH1, TH2, TH3 and TH4 can be any positive integers.

$$( Equation 24 )$$

$$for top boundary \{ \begin{matrix}pred ( i , 0 ) = ( 31 * {Pred}_{C} ( i , 0 ) + 1 * {Pred}_{N} ( i , 0 ) + 16 ) ≫ 5 ) & , 0 \leq i < 4 \\ pred ( i , 1 ) = {Pred}_{C} ( i , 1 ) & , 0 \leq i < 4 \\ pred ( i , 2 ) = {Pred}_{C} ( i , 2 ) & , 0 \leq i < 4 \\ pred ( i , 3 ) = {Pred}_{C} ( i , 3 ) & , 0 \leq i < 4\end{matrix}$$

$$for top boundary \{ \begin{matrix}pred ( 0 , j ) = ( 31 * {Pred}_{C} ( 0 , j ) + 1 * {Pred}_{N} ( 0 , j ) + 16 ) ≫ 5 ) & , 0 \leq j < 4 \\ pred ( 1 , j ) = {Pred}_{C} ( 1 , j ) & , 0 \leq j < 4 \\ pred ( 2 , j ) = {Pred}_{C} ( 2 , j ) & , 0 \leq j < 4 \\ pred ( 3 , j ) = {Pred}_{C} ( 3 , j ) & , 0 \leq j < 4\end{matrix}$$

In some embodiments, for a sub-block, when intra OBMC is performed, pred_{C} can be regarded as the prediction signal before OBMC, and pred can be regarded as the prediction signal after OBMC, which is a blending of pred_{C} and pred_{N}. It is proposed that pred_{C} and pred can be further blended to generate the final prediction signal of the current block, based on Equation 25, where w can be calculated based on the SAD value between pred_{C} and pred_{N} according to Equation 26, where TH is a threshold.

$${pred ( i , j )}^{′} = w * {pred}_{C} ( i , j ) + ( 1 - w ) * pred ( i , j ) \qquad ( Equation 25 )$$

$$w = \{ \begin{matrix}1 , SAD \geq TH \\ \frac{SAD}{TH} , SAD < TH\end{matrix} \qquad ( Equation 26 )$$

In some embodiments, the intra OBMC can be performed to all CUs predicted by intra TMP mode or IBC mode without any signalling. In some embodiments, whether to perform intra OBMC to a CU can be determined by the number of samples in the CU. In some embodiments, whether to perform intra OBMC to a CU can be determined by the prediction mode of the current CU. For example, when the current CU is predicted by IBC GPM mode or IBC CIIP mode or RR-IBC mode, the intra OBMC is not performed. For another example, when the current CU is predicted by IBC AMVP mode, the intra OBMC is not performed. For yet another example, when the current CU is predicted by Intra TMP fusion mode, the intra OBMC is not performed. In some embodiments, whether to performed intra OBMC to a CU can be determined by the type of the current slice. For example, the OBMC is only performed to CUs in I slices. In some embodiments, whether to performed intra OBMC to a CU can be determined by a SPS level flag. In some embodiments, the SPS flag is set to false for screen content sequences, which means intra OBMC is disabled for screen content sequences. In some embodiments, intra OBMC is not performed for chroma blocks.

In some embodiments, a CU level flag is signaled to indicate whether to perform intra OBMC to the CU. In some embodiments, whether to signal the flag is determined by the prediction mode of the current CU. For example, if the current CU is predicted by IBC AMVP mode, a flag is signaled to indicate whether to perform intra OBMC to the CU; otherwise, intra OBMC is always performed without any signaling.

In some embodiments, whether to performed intra OBMC to a sub-block is determined by the prediction of the neighboring sub-block. For a sub-block in the top boundary, the prediction mode of the top neighboring sub-block is used for the determination. For a sub-block in the left boundary, the prediction mode of the left neighboring sub-block is used for the determination. For example, if the prediction mode of the neighboring sub-block is IBC GPM mode, IBC CIIP mode, or RR-IBC mode, the intra OBMC is not performed for the current sub-block. For another example, if the prediction mode of the neighboring sub-block is intra TMP fusion mode, the intra OBMC is not performed for the current sub-block.

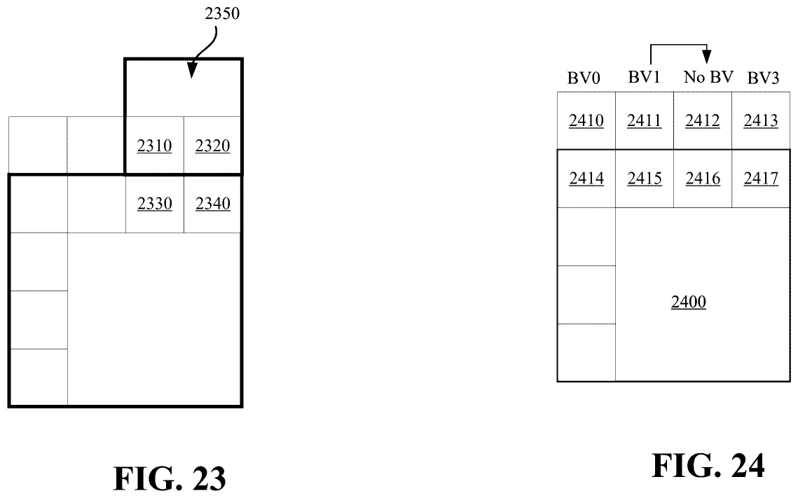

FIG. 23 is a schematic diagram illustrating merged sub-blocks when intra OBMC is performed, according to some embodiments of the present disclosure. In some embodiments, consecutive sub-blocks can be merged to perform intra OBMC. For example, whether to merge sub-blocks can be determined based on whether the neighboring sub-blocks are in the same CU. For example, as shown in FIG. 23, if the top neighboring sub-blocks 2310 and 2320 of the sub-block 2330 and the sub-block 2340 are in the same CU 2350, sub-block 2330 and sub-block 2340 can be merged to a larger sub-block to perform intra OBMC. That is, if the original sub-block 2330 and 2340 are 4×4, then the size of the merged sub-block is 8×4.

As another example, whether to merge sub-blocks can be determined based on whether the BVs and the prediction mode parameters of the neighboring sub-blocks are the same. In some embodiments, inherit prediction parameters can be used. In some embodiments, when performing the intra OBMC to a sub-block, pred_{N} is not only generated by using BV_{N}, but also by the prediction parameters of the neighboring sub-block. In other words, the prediction parameters of the neighboring sub-block are inherited to the current sub-block to obtain pred_{N}.

For example, when the neighboring sub-block is predicted by Intra TMP filter mode, the filter coefficients are inherited. Accordingly, the current sub-block is also predicted by Intra TMP filter mode with BV_{N}, and the filter coefficients from the neighboring sub-block is used for the current sub-block to do Intra TMP filter to generate pred_{N}. In some embodiments, when the neighboring sub-block is predicted by Intra TMP filter mode, only the BV_{N} (which is the block vector stored in the neighboring sub-block) is used to generate pred_{N} without filtering. In some embodiments, when the neighboring sub-block is predicted by Intra TMP filter mode, the intra OBMC is not performed.

As another example, when the neighboring sub-block is predicted by Intra TMP fusion mode, the used block vectors and the fusion weights are inherited. Accordingly, the current sub-block is also predicted by Intra TMP fusion mode with the block vectors and the fusion weights used in the neighboring sub-block to generate pred_{N}. In some embodiments, when at least one of the block vectors used in fusion is not available for the current sub-block, only the available block vectors are used to generate pred_{N}. In some embodiments, when at least one of the block vectors used in fusion is not available for the current sub-block, the intra OBMC is not performed for the current sub-block. In some embodiments, when the neighboring sub-block is predicted by Intra TMP fusion mode, only the BV_{N} (which is the block vector stored in the neighboring sub-block) is used to generate pred_{N} without fusion. In some embodiments, when the neighboring sub-block is predicted by Intra TMP fusion mode, the intra OBMC is not performed.

As another example, when the neighboring sub-block is predicted by Intra TMP sub-pel mode, the used sub-pel precision and direction are inherited. Accordingly, the current sub-block is also predicted by Intra TMP sub-pel mode with BV_{N}, the sub-pel precision and direction used in the neighboring sub-block to generate pred_{N}. In some embodiments, when the neighboring sub-block is predicted by Intra TMP sub-pel mode, only the BV_{N} (which is the block vector stored in the neighboring sub-block) is used to generate pred_{N} without sub-pel operation.

As another example, when the neighboring sub-block is predicted by Intra TMP LIC mode, the LIC parameters are inherited. Accordingly, the current sub-block is also predicted by Intra TMP LIC mode with BV_{N}, and the LIC parameters from the neighboring sub-block are used for the current sub-block to do LIC filter to generate pred_{N}. In some embodiments, when the neighboring sub-block is predicted by IBC LIC mode, only the BV_{N} (which is the block vector stored in the neighboring sub-block) is used to generate pred_{N} without LIC filtering. In some embodiments, when the neighboring sub-block is predicted by Intra TMP LIC mode, the intra OBMC is not performed.

In some embodiments, when the neighboring sub-block is predicted by Intra TMP LIC mode and intra TMP fusion mode, both the LIC parameters and fusion parameters are inherited in performing intra OBMC.

As another example, when the neighboring sub-block is predicted by IBC LIC mode, the LIC parameters are inherited. Accordingly, the current sub-block is also predicted by IBC LIC mode with BV_{N}, and the LIC parameters from the neighboring sub-block are used for the current sub-block to do LIC filter to generate pred_{N}. In some embodiments, when the neighboring sub-block is predicted by IBC LIC mode, only the BV_{N} (which is the block vector stored in the neighboring sub-block) is used to generate pred_{N} without LIC filtering. In some embodiments, when the neighboring sub-block is predicted by IBC LIC mode, the intra OBMC is not performed.

As another example, when the neighboring sub-block is predicted by IBC CIIP mode, the intra prediction mode and weights are inherited. Accordingly, the current sub-block is also predicted by IBC CIIP mode, the prediction signal obtained by BV_{N} and prediction signal obtained by the intra prediction mode are weighted with the weights from the neighboring sub-block to generate pred_{N}. In some embodiments, when the neighboring sub-block is predicted by IBC CIIP mode, only the BV_{N} (which is the block vector stored in the neighboring sub-block) is used to generate pred_{N} without weighted with an intra prediction mode. In some embodiments, when the neighboring sub-block is predicted by IBC CIIP mode, the intra OBMC is not performed.

As another example, when the neighboring sub-block is predicted by IBC GPM mode, the intra prediction mode and the geometry partitioning mode are inherited. Accordingly, the current sub-block is also predicted by IBC GPM mode with BV_{N}, the prediction signal and the partitioning mode from the neighboring sub-block to generate Pred_{N}. In some embodiments, when the neighboring sub-block is predicted by IBC GPM mode, only the BV_{N} (which is the block vector stored in the neighboring sub-block) is used to generate pred_{N} without weighted with geometry partitioning. In some embodiments, when the neighboring sub-block is predicted by IBC GPM mode, the intra OBMC is not performed.

As another example, when the neighboring sub-block is predicted by IBC filter mode, the filter coefficients are inherited. Accordingly, the current sub-block is also predicted by IBC filter mode with BV_{N}, and the filter coefficients from the neighboring sub-block is used for the current sub-block to do IBC filter to generate pred_{N}. In some embodiments, when the neighboring sub-block is predicted by IBC filter mode, only the BV_{N} (which is the block vector stored in the neighboring sub-block) is used to generate pred_{N} without filtering. In some embodiments, when the neighboring sub-block is predicted by IBC filter mode, the intra OBMC is not performed.

As another example, when the neighboring sub-block is predicted by BI-IBC mode, the used block vectors and the fusion weights are inherited. Accordingly, the current sub-block is also predicted by BI-IBC mode with the two block vectors and the fusion weights used in the neighboring sub-block to generate pred_{N}. In some embodiments, when at least one of the block vectors used in fusion is not available for the current sub-block, only the available block vector is used to generate pred_{N} without fusion. In some embodiments, when at least one of the block vectors used in fusion is not available for the current sub-block, the intra OBMC is not performed for the current sub-block. In some embodiments, when the neighboring sub-block is predicted by BI-IBC mode, only the BV_{N} (which is the block vector stored in the neighboring sub-block) is used to generate Pred_{N} without fusion. In some embodiments, when the neighboring sub-block is predicted by BI-IBC mode, the intra OBMC is not performed.

As another example, when the neighboring sub-block is predicted by RR-IBC mode, the intra OBMC is not performed for the current sub-block.

In the aforementioned embodiments, when the neighboring sub-block is predicted by an intra prediction mode (e.g., non-Intra TMP mode and non-IBC mode, or no block vector is stored), the intra OBMC is not performed for the current sub-block.

In some embodiments, when the neighboring sub-block is predicted by an intra prediction mode, intra OBMC can be performed by using the stored conventional intra prediction mode (e.g., one of the angular modes, planar mode and DC mode) of the neighboring sub-block to generate pred_{N} of the current sub-block.

FIG. 24 is a schematic diagram illustrating padding a block vector of a neighboring sub-block, according to some embodiments of the present disclosure. In some embodiments, when the neighboring sub-block (e.g., any of sub-blocks 2410-2413) is predicted by an intra prediction mode, intra OBMC can be performed by deriving a block vector to generate pred_{N} of the current sub-block (e.g., any of sub-blocks 2414-2417). For example, a padding method can be used to derive the block vector of an intra prediction mode coded neighboring block. Specifically, for a neighboring sub-block (e.g., sub-block 2412) in the top boundary of a CU 2400, if there is no stored block vector, the block vector (e.g., BV1 or BV3) from left and right adjacent sub-blocks (e.g., sub-blocks 2411 and 2413) can be padded to the neighboring sub-block. Similarly, for a neighboring sub-block in the left boundary of a CU, if there is no stored block vector, the block vector from top and bottom adjacent sub-blocks can be padded to the neighboring sub-block. For example, as shown in FIG. 24, the neighboring sub-block 2412 is predicted by an intra prediction mode so that it has no stored block vector, then the block vector BV1 of neighboring sub-block 2411 can be padded to the neighboring sub-block 2412. When performing intra OBMC of the sub-block 2416, block vector BV1 can be used to generate pred_{N}. For another example, when performing intra OBMC of the sub-block 2416, both block vector BV1 and BV3 are used to generate pred_{N}.

In some embodiments, not only the block vector is padded, but also the prediction parameters are padded, such as the prediction mode, the filter coefficients of Intra TMP filter mode, the block vectors and the fusion weights of the Intra TMP fusion mode, sub-pel precision and direction of the Intra TMP sub-pel mode, the LIC parameters of IBC LIC mode, the intra prediction mode and weights in IBC CIIP mode, the intra prediction mode and the geometry partitioning mode of IBC GPM mode, and so on.

In some embodiments, when the neighboring sub-block is predicted by an intra prediction mode (non-BV mode), intra OBMC can be performed by deriving a conventional intra prediction mode of the neighboring sub-block and use this mode to generate pred_{N} of the current sub-block.

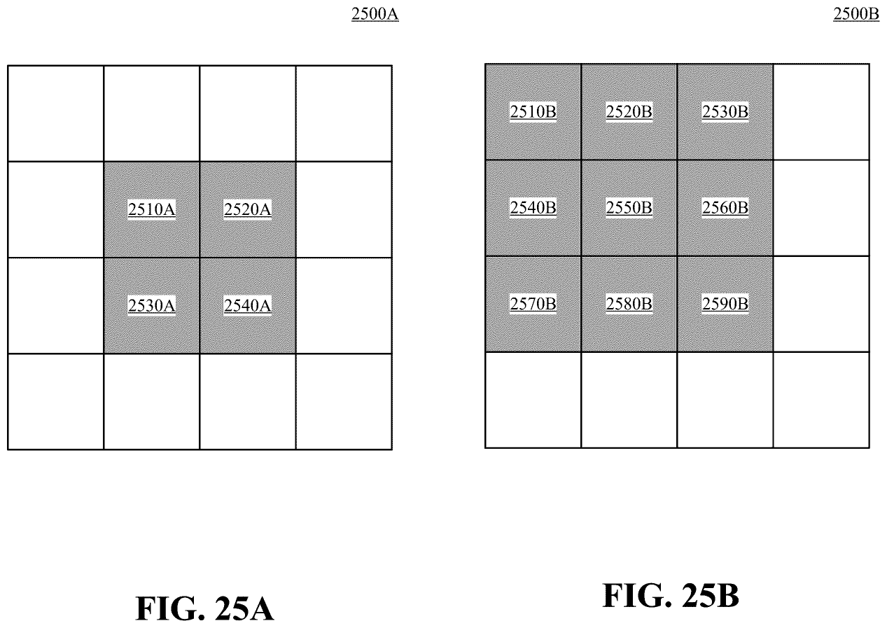

The conventional intra prediction modes can be derived by a gradient-based method like DIMD. In some embodiments, the reconstructed samples within the neighboring sub-block are used to derive the conventional intra prediction mode. FIG. 25A is a schematic diagram illustrating samples used for deriving an intra prediction mode in a 4×4 sub-block, according to some embodiments of the present disclosure.

For example, as shown in FIG. 25A, 4 samples 2510A-2540A within a 4×4 sub-block 2500A are used to derive the conventional intra prediction mode. For each sample, a horizontal gradient and a vertical gradient are carried out by applying 3×3 horizontal and vertical Sobel filters. Then a histogram of gradient is built and the conventional intra prediction mode with the highest amplitude is selected to generate pred_{N} in intra OBMC process.

FIG. 25B is a schematic diagram illustrating samples used for deriving an intra prediction mode in a 4×4 sub-block 2500B, according to some embodiments of the present disclosure.

In some embodiments, two 2×2 filters are used to calculate the horizontal gradient and vertical gradients. Then the 9 samples 2510B-2590B as shown in FIG. 25B can be used. In some embodiments, the samples 2510B-2590B used for deriving are determined based on the availability of the neighboring samples.

In some embodiments, whether to use 2×2 filters or 3×3 filters is determined based on the blocks size of the current block.

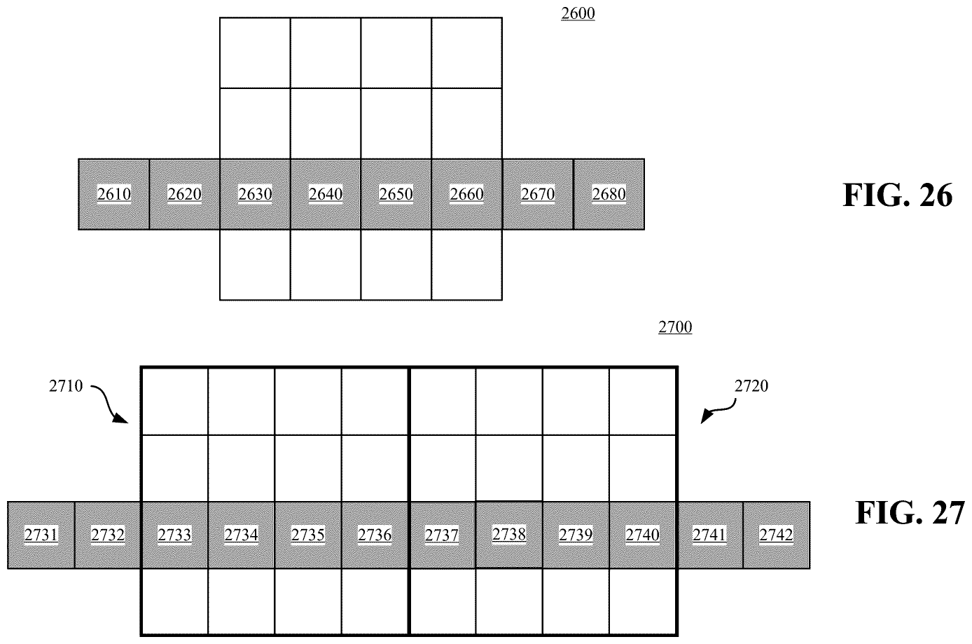

As another example, for a neighboring sub-block, the reconstructed samples within the sub-blocks and adjacent to the sub-block can be used together to derive the conventional intra mode. FIG. 26 is a schematic diagram illustrating samples used for deriving an intra prediction mode in a 4×4 sub-block 2600, according to some embodiments of the present disclosure. For example, as shown in FIG. 26, the grey samples 2610-2680 are used for deriving if the adjacent samples used in gradients calculation are available.

FIG. 27 is a schematic diagram illustrating samples used for deriving an intra prediction mode in a merged block 2700, according to some embodiments of the present disclosure. In some embodiments, different neighboring sub-blocks can be merged and the reconstructed samples of the merged neighboring block are used to derive the conventional intra mode. Each neighboring sub-block in one merged neighboring block will have the same derived conventional intra mode. For example, two 4×4 neighboring sub-blocks 2710 and 2720 are merged and the grey samples 2731-2742 are used for deriving as shown in FIG. 27.

In some embodiments, the neighboring sub-blocks in a same CU can be merged to derive the conventional intra mode. In some other embodiments, the neighboring sub-blocks predicted by intra prediction modes (non-BV modes) can be merged. For another example, the neighboring sub-blocks predicted by the same type of intra prediction modes can be merged. In some embodiments, only the consecutive neighboring sub-blocks can be merged. In some embodiments, discontinuous neighboring sub-blocks can also be merged.

In some embodiments, whether to use 2×2 filters or 3×3 filters can be determined based on the blocks size of the merge neighboring block.

After deriving the conventional intra mode of neighboring sub-blocks, the corresponding sub-block in the current block can be predicted by the derived conventional intra mode.

In some embodiments, different sub-blocks in the boundary of the current block with the same derived conventional intra mode can be merged to be predicted to generate pred_{N} of the merged block.

In some embodiments, a restriction is applied to the derived conventional intra mode. For sub-blocks in the top boundary of the current block, if the derived conventional intra mode has index between 34 to 66, the intra OBMC is performed; otherwise, the intra OBMC is not performed. For sub-blocks in the left boundary of the current block, if the derived conventional intra mode has index between 2 to 34, the intra OBMC is performed; otherwise, the intra OBMC is not performed.

In some embodiments, when a sub-block or a merge block is predicted using the derived conventional intra mode, the intra fusion, MIP replacement method and PDPC is disabled.

In some embodiments, when the current CU is predicted by intra prediction mode (no block vector), the intra OBMC can also be performed, where pred_{C} is the prediction signal obtained based on the intra prediction mode and the other part kept unchanged with the aforementioned intra OBMC process. For example, if the current block is coded by EIP mode, the intra OBMC process can be applied.

In various embodiments, the aforementioned intra OBMC method can be used for chroma blocks. For 4:2:0 format, both width and height of the sub-block are half of those of the sub-block for luma intra OBMC. For example, if the sub-block for luma intra OBMC is 4×4, then the sub-block for chroma intra OBMC is 2×2.

In some embodiments, if the current block is coded by chroma DBV mode, the intra OBMC method is applied. For example, if a neighboring sub-block is coded by chroma DBV mode, the block vector of the neighboring sub-block can be used to generate pred_{N} of the current sub-block. Then pred_{N} and pred_{C} obtained by applying the block vector of the current block are fused to generate the final prediction of the current sub-block.

As another example, if a neighboring sub-block is coded by a non-chroma DBV mode, a conventional intra prediction mode is derived and used to generate pred_{N} of the current sub-block. On the other hand, if a neighboring sub-block is coded by a non-chroma DBV mode and non-CCP mode, a conventional intra prediction mode is derived and used to generate pred_{N} of the current sub-block.

As another example, if a neighboring sub-block is coded by a CCP mode, the CCP parameters of the neighboring sub-block can be used to generate pred_{N} of the current sub-block.

In some embodiments, if the current block is coded by a CCP mode, the intra OBMC method is applied. For example, if a neighboring sub-block is coded by a CCP mode, then the CCP parameters of the neighboring sub-block is used to generate pred_{N} of the current sub-block. Then pred_{N} and pred_{C} obtained by applying the CCP parameters of the current block are fused to generate the final prediction of the current sub-block. On the other hand, if a neighboring sub-block is coded by a non-CCP mode, a conventional intra prediction mode can be derived and used to generate pred_{N} of the current sub-block.

As another example, if a neighboring sub-block is coded by a non-chroma DBV mode and non-CCP mode, a conventional intra prediction mode is derived and used to generate pred_{N} of the current sub-block.

As another example, if a neighboring sub-block is coded by a chroma DBV mode, the block vector of the neighboring sub-block is used to generate pred_{N} of the current sub-block.

In some embodiments, the intra OBMC can be applied under the following scenarios: (1) the current block is coded by IBC or intra TMP mode and a neighboring sub-block is coded by IBC or intra TMP mode, with all the prediction parameters from the neighboring sub-block being used to predict the current sub-block; (2) the current block is coded by IBC or intra TMP mode and a neighboring sub-block is coded by an intra prediction mode (non-BV and non-PLT and non-BDPCM); or (3) the current block is coded by CCP mode and a neighboring sub-block is coded by an intra prediction mode (non-BV and non-CCP).

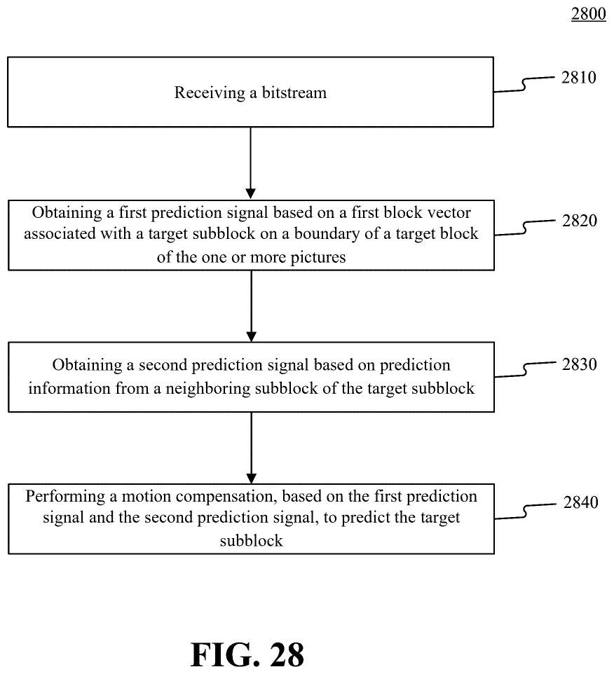

FIG. 28 is a flowchart of an example method 2800 of decoding a bitstream to output one or more pictures for a video stream, according to some embodiments of the present disclosure. In some embodiments, the method 2800 can be performed by a decoder (e.g., decoder 300 in FIG. 3). For example, the decoder can be implemented as one or more software or hardware components of an apparatus (e.g., apparatus 400 in FIG. 4) for decoding the bitstream (e.g., video bitstream 228 in FIG. 3) to reconstruct a video frame or a video sequence (e.g., video stream 304 in FIG. 3) of the bitstream. For example, a processor (e.g., processor 402 in FIG. 4) can perform the method 2800. As shown in FIG. 28, the method 2800 may include steps 2810-2840.

Referring to the method 2800, at step 2810, the decoder receives a bitstream (e.g., video bitstream 228 in FIG. 3). After receiving the bitstream, at steps 2820-2840, the decoder decodes, using coded information of the bitstream, one or more pictures of a video sequence. In particular, at step 2820, the decoder obtains a first prediction signal (e.g., prediction signal pred_{C} in FIG. 22) based on a first block vector (e.g., block vector BV^{c} in FIG. 22) associated with a target subblock (e.g., sub-block 2210) on a boundary of a target block of the one or more pictures. As shown in FIG. 22, the boundary of the target block may include a top boundary or a left boundary of the target block. As discussed above, the first prediction signal can be obtained by performing an intra TMP mode or an intra block copy (IBC) mode of the target subblock.

At step 2830, the decoder obtains a second prediction signal (e.g., prediction signal pred_{N} in FIG. 22) based on prediction information from a neighboring subblock (e.g., sub-block 2220) of the target subblock. In some embodiments, at step 2830, in respond to a prediction mode of the neighboring subblock being an intra template matching prediction (TMP) mode or an intra block copy (IBC) mode, the second prediction signal can be obtained based on a second block vector (e.g., block vector BV_{N} in FIG. 22) associated with the neighboring subblock. On the other hand, in respond to the prediction mode of the neighboring subblock being different from an intra TMP mode or an IBC mode, the second prediction signal can be obtained based on an intra prediction mode associated with the neighboring subblock. For example, the decoder can obtain the second prediction signal by using one of an angular mode, a planar mode, or a DC mode when the neighboring subblock is predicted by an intra prediction mode. The decoder may derive the intra prediction mode based on a gradient of the neighboring subblock, as described in the above embodiments.

At step 2840, the decoder performs, based on the first prediction signal and the second prediction signal, a motion compensation to predict the target subblock. For example, in some embodiments, the decoder is configured to blend the first prediction signal and the second prediction signal to obtain a third prediction signal (e.g., prediction signal pred (i, j)) for the target subblock. In particular, the decoder can obtain the third prediction signal based on the first prediction signal, the second prediction signal, multiple weights for the first prediction signal, and multiple weights for the second prediction signal, based on the equations provided in the present disclosure. In some embodiments, the decoder can determine one or more weights to be used for blending in the intra OBMC based on the first prediction signal and the second prediction signal. For example, as discussed above, the maximum value of the absolute difference between pred_{C} and pred_{N} can be recorded as max and used to determine the weight use for blending for a sub-block in intra OBMC.

In some embodiments, at step 2840, the decoder may further blend the first prediction signal and the third prediction signal to obtain a fourth prediction signal (e.g., prediction signal pred (i, j)′) for performing intra OBMC to predict the target subblock. For example, as shown in Equation 25, pred_{C} and pred can be further blended to generate the final prediction signal of the current block.

In some embodiments, in response to the neighboring subblock or the second block vector being unavailable (e.g., being out of the frame or slice boundary, or not reconstructed yet), step 2830 is skipped and step 2840 can be modified to have the decoder use the first prediction signal for predicting the target subblock.

In some embodiments, the decoder may determine whether to perform the intra OBMC to the target subblock based on the first prediction signal and the second prediction signal. Various conditions for determining whether to perform the intra OBMC to the target subblock have been discussed in detail in the above embodiments, and thus are not repeated herein for the sake of brevity.

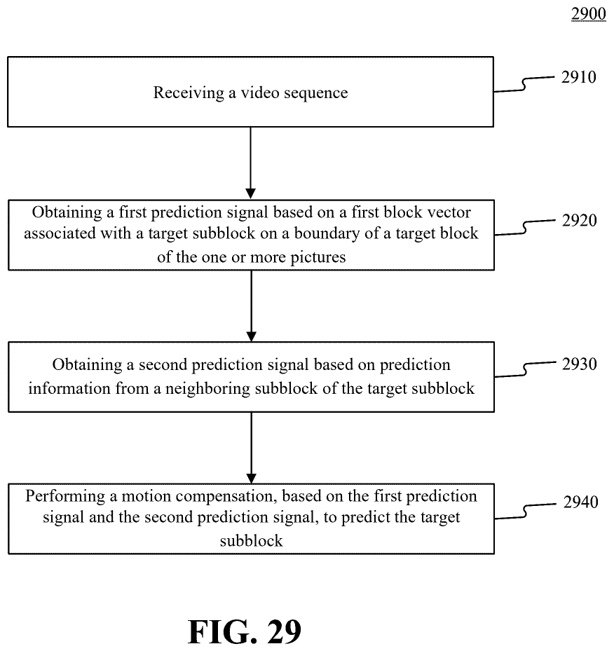

FIG. 29 is a flowchart for an example method 2900 of encoding a video sequence into a bitstream, according to some embodiments of the present disclosure. The method 2900 can be performed by an encoder (e.g., encoder 200 in FIG. 2) to encode a video bitstream. For example, the encoder can be implemented as one or more software or hardware components of an apparatus (e.g., apparatus 400 in FIG. 4) for encoding the bitstream (e.g., video bitstream 228 in FIG. 2) for reconstructing a video frame or a video sequence. For example, a processor (e.g., processor 402 in FIG. 4) can perform the method 2900. As shown in FIG. 29, the method 2900 includes the following steps 2910-2940.

At step 2910, the encoder receives a video sequence (e.g., video sequence 202 in FIG. 2). Then, at steps 2920-2940, the encoder encodes one or more pictures of the video sequence to generate a bitstream. In particular, at step 2920, the encoder obtains a first prediction signal (e.g., prediction signal pred_{C} in FIG. 22) based on a first block vector (e.g., block vector BV^{c} in FIG. 22) associated with a target subblock (e.g., sub-block 2210) on a boundary of a target block of the one or more pictures. At step 2930, the encoder obtains a second prediction signal (e.g., prediction signal pred_{N} in FIG. 22) based on prediction information from a neighboring subblock (e.g., sub-block 2220) of the target subblock. At step 2940, the encoder performs, based on the first prediction signal and the second prediction signal, a motion compensation to predict the target subblock.

Detailed operations of steps 2920-2940 are similar or the same as those in step 2820-2840 of the method 2800 in FIG. 28, and thus are not repeated herein for the sake of brevity. For example, in some embodiments, in response to the neighboring subblock or the second block vector being unavailable (e.g., being out of the frame or slice boundary, or not reconstructed yet), step 2930 is skipped and step 2940 can be modified to have the encoder use the first prediction signal for predicting the target subblock.

The embodiments described in the present disclosure can be freely combined.

In some embodiments, a non-transitory computer-readable storage medium storing a bitstream is also provided. The bitstream can be encoded and decoded according to the disclosed methods of overlapped block motion compensation for Intra TMP and IBC.

In some embodiments, a method for transmitting a bitstream includes operations of: receiving a video sequence including one or more pictures, encoding the video sequence, and signaling a bitstream generated based on the encoding. The video sequence is encoded by: obtaining a first prediction signal based on a first block vector associated with a target subblock on a boundary of a target block of the one or more pictures, obtaining a second prediction signal based on prediction information from a neighboring subblock of the target subblock, and performing a motion compensation, based on the first prediction signal and the second prediction signal, to predict the target subblock. Details of the operations of encoding the video sequence are similar or the same as those in the method 2900 in FIG. 29, and thus are not repeated herein for the sake of brevity.

In some embodiments, a non-transitory computer-readable storage medium including instructions is also provided, and the instructions may be executed by a device (such as the disclosed encoder and decoder), for performing the above-described methods. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The device may include one or more processors (CPUs), an input/output interface, a network interface, and/or a memory.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

The embodiments may further be described using the following clauses:

1. A method of decoding a bitstream, the method comprising:
receiving a bitstream; and
decoding, using coded information of the bitstream, one or more pictures, by:
   obtaining a first prediction signal based on a first block vector associated with a target subblock on a boundary of a target block of the one or more pictures;
   obtaining a second prediction signal based on prediction information from a neighboring subblock of the target subblock; and
   performing a motion compensation, based on the first prediction signal and the second prediction signal, to predict the target subblock.

2. The method according to clause 1, wherein obtaining the second prediction signal based on prediction information from the neighboring subblock of the target subblock comprises:
in respond to a prediction mode of the neighboring subblock being an intra template matching prediction (TMP) mode or an intra block copy (IBC) mode, obtaining the second prediction signal based on a second block vector associated with the neighboring subblock.

3. The method according to clause 1 or 2, wherein obtaining the second prediction signal based on prediction information from the neighboring subblock of the target subblock comprises:
in respond to a prediction mode of the neighboring subblock being different from an intra template matching prediction (TMP) mode or an intra block copy (IBC) mode, obtaining the second prediction signal based on an intra prediction mode associated with the neighboring subblock.

4. The method according to clause 3, wherein the intra prediction mode is one of an angular mode, a planar mode, or a DC mode.

5. The method according to clause 3 or 4, wherein obtaining the second prediction signal based on the prediction mode associated with the neighboring subblock further comprises: deriving the intra prediction mode based on a gradient of the neighboring subblock.

6. The method according to any of clauses 1-5, wherein the boundary of the target block comprises a top boundary or a left boundary of the target block.

7. The method according to any of clauses 1-6, further comprising:
blending the first prediction signal and the second prediction signal to obtain a third prediction signal for the target subblock.

8. The method according to claim 7, wherein blending the first prediction parameter and the second prediction parameter comprises:
obtain the third prediction signal based on the first prediction signal, the second prediction signal, a plurality of weights for the first prediction signal, and a plurality of weights for the second prediction signal.

9. The method according to any of clauses 1-8, wherein obtaining the first prediction signal comprises:
performing an intra template matching prediction (TMP) mode or an intra block copy (IBC) mode of the target subblock to obtain the first prediction signal.

10. A method of encoding a video sequence into a bitstream, the method comprising:
receiving a video sequence; and
encoding one or more pictures of the video sequence to generate a bitstream, wherein the encoding comprises:
   obtaining a first prediction signal based on a first block vector associated with a target subblock on a boundary of a target block of the one or more pictures;
   obtaining a second prediction signal based on prediction information from a neighboring subblock of the target subblock; and
   performing a motion compensation, based on the first prediction signal and the second prediction signal, to predict the target subblock.

11. The method according to clause 10, wherein obtaining the second prediction signal based on prediction information from the neighboring subblock of the target subblock comprises:
in respond to a prediction mode of the neighboring subblock being an intra template matching prediction (TMP) mode or an intra block copy (IBC) mode, obtaining the second prediction signal based on a second block vector associated with the neighboring subblock.

12. The method according to clause 10 or 11, wherein obtaining the second prediction signal based on prediction information from the neighboring subblock of the target subblock comprises:
in respond to a prediction mode of the neighboring subblock being different from an intra template matching prediction (TMP) mode or an intra block copy (IBC) mode, obtaining the second prediction signal based on an intra prediction mode associated with the neighboring subblock.

13. The method according to claim 12, wherein the intra prediction mode is one of an angular mode, a planar mode, or a DC mode.

14. The method according to clause 12 or 13, wherein obtaining the second prediction signal based on the prediction mode associated with the neighboring subblock further comprises: deriving the intra prediction mode based on a gradient of the neighboring subblock.

15. The method according to any of clauses 10-14, wherein the boundary of the target block comprises a top boundary or a left boundary of the target block.

16. The method according to any of clauses 10-15, further comprising:
blending the first prediction signal and the second prediction signal to obtain a third prediction signal for the target subblock.

17. The method according to clause 16, wherein blending the first prediction signal and the second prediction signal comprises:
obtain the third prediction signal based on the first prediction signal, the second prediction signal, a plurality of weights for the first prediction signal, and a plurality of weights for the second prediction signal.

18. The method according to any of clauses 10-17, wherein the first prediction signal is obtained by:
performing an intra template matching prediction (TMP) mode or an intra block copy (IBC) mode of the target subblock to obtain the first prediction signal.

19. A method for transmitting a bitstream, comprising:
receiving a video sequence including one or more pictures;
encoding the video sequence by:
   obtaining a first prediction signal based on a first block vector associated with a target subblock on a boundary of a target block of the one or more pictures;
   obtaining a second prediction signal based on prediction information from a neighboring subblock of the target subblock; and
   performing a motion compensation, based on the first prediction signal and the second prediction signal, to predict the target subblock; and
signaling a bitstream generated based on the encoding.

20. The method according to clause 19, wherein obtaining the second prediction signal comprises:
when the neighboring subblock is predicted by an intra prediction mode, using at least one of an angular mode, a planar mode, or a DC mode of the neighboring subblock to obtain the second prediction signal.

It is appreciated that the above-described embodiments can be implemented by hardware, or software (program codes), or a combination of hardware and software. If implemented by software, it may be stored in the above-described computer-readable media. The software, when executed by the processor can perform the disclosed methods. The computing units and other functional units described in the present disclosure can be implemented by hardware, or software, or a combination of hardware and software. One of ordinary skill in the art will also understand that multiple ones of the above-described modules/units may be combined as one module/unit, and each of the above-described modules/units may be further divided into a plurality of sub-modules/sub-units.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

In the drawings and specification, there have been disclosed exemplary embodiments. However, many variations and modifications can be made to these embodiments. Accordingly, although specific terms are employed, they are used in a generic and descriptive sense only and not for purposes of limitation.

What is claimed is:

1. A method of decoding a bitstream, the method comprising:
receiving a bitstream; and
decoding, using coded information of the bitstream, one or more pictures, by:
obtaining a first prediction signal based on a first block vector associated with a target subblock on a boundary of a target block of the one or more pictures;
obtaining a second prediction signal based on prediction information from a neighboring subblock of the target subblock; and
performing a motion compensation, based on the first prediction signal and the second prediction signal, to predict the target subblock.

2. The method according to claim 1, wherein obtaining the second prediction signal based on prediction information from the neighboring subblock of the target subblock comprises:
in respond to a prediction mode of the neighboring subblock being an intra template matching prediction (TMP) mode or an intra block copy (IBC) mode, obtaining the second prediction signal based on a second block vector associated with the neighboring subblock.

3. The method according to claim 1, wherein obtaining the second prediction signal based on prediction information from the neighboring subblock of the target subblock comprises:
in respond to a prediction mode of the neighboring subblock being different from an intra template matching prediction (TMP) mode or an intra block copy (IBC) mode, obtaining the second prediction signal based on an intra prediction mode associated with the neighboring subblock.

4. The method according to claim 3, wherein the intra prediction mode is one of an angular mode, a planar mode, or a DC mode.

5. The method according to claim 3, wherein obtaining the second prediction signal based on the prediction mode associated with the neighboring subblock further comprises:
deriving the intra prediction mode based on a gradient of the neighboring subblock.

6. The method according to claim 1, wherein the boundary of the target block comprises a top boundary or a left boundary of the target block.

7. The method according to claim 1, further comprising:
blending the first prediction signal and the second prediction signal to obtain a third prediction signal for the target subblock.

8. The method according to claim 7, wherein blending the first prediction parameter and the second prediction parameter comprises:
obtain the third prediction signal based on the first prediction signal, the second prediction signal, a plurality of weights for the first prediction signal, and a plurality of weights for the second prediction signal.

9. The method according to claim 1, wherein obtaining the first prediction signal comprises:
performing an intra template matching prediction (TMP) mode or an intra block copy (IBC) mode of the target subblock to obtain the first prediction signal.

10. A method of encoding a video sequence into a bitstream, the method comprising:
receiving a video sequence; and
encoding one or more pictures of the video sequence to generate a bitstream, wherein the encoding comprises:
obtaining a first prediction signal based on a first block vector associated with a target subblock on a boundary of a target block of the one or more pictures;
obtaining a second prediction signal based on prediction information from a neighboring subblock of the target subblock; and
performing a motion compensation, based on the first prediction signal and the second prediction signal, to predict the target subblock.

11. The method according to claim 10, wherein obtaining the second prediction signal based on prediction information from the neighboring subblock of the target subblock comprises:
in respond to a prediction mode of the neighboring subblock being an intra template matching prediction (TMP) mode or an intra block copy (IBC) mode, obtaining the second prediction signal based on a second block vector associated with the neighboring subblock.

12. The method according to claim 10, wherein obtaining the second prediction signal based on prediction information from the neighboring subblock of the target subblock comprises:
in respond to a prediction mode of the neighboring subblock being different from an intra template matching prediction (TMP) mode or an intra block copy (IBC) mode, obtaining the second prediction signal based on an intra prediction mode associated with the neighboring subblock.

13. The method according to claim 12, wherein the intra prediction mode is one of an angular mode, a planar mode, or a DC mode.

14. The method according to claim 12, wherein obtaining the second prediction signal based on the prediction mode associated with the neighboring subblock further comprises:
deriving the intra prediction mode based on a gradient of the neighboring subblock.

15. The method according to claim 10, wherein the boundary of the target block comprises a top boundary or a left boundary of the target block.

16. The method according to claim 10, further comprising:
blending the first prediction signal and the second prediction signal to obtain a third prediction signal for the target subblock.

17. The method according to claim 16, wherein blending the first prediction signal and the second prediction signal comprises:
obtain the third prediction signal based on the first prediction signal, the second prediction signal, a plurality of weights for the first prediction signal, and a plurality of weights for the second prediction signal.

18. The method according to claim 10, wherein the first prediction signal is obtained by:
performing an intra template matching prediction (TMP) mode or an intra block copy (IBC) mode of the target subblock to obtain the first prediction signal.

19. A method for transmitting a bitstream, comprising:
receiving a video sequence including one or more pictures;
encoding the video sequence by:
obtaining a first prediction signal based on a first block vector associated with a target subblock on a boundary of a target block of the one or more pictures;
obtaining a second prediction signal based on prediction information from a neighboring subblock of the target subblock; and
performing a motion compensation, based on the first prediction signal and the second prediction signal, to predict the target subblock; and
signaling a bitstream generated based on the encoding.

20. The method according to claim 19, wherein obtaining the second prediction signal comprises:
when the neighboring subblock is predicted by an intra prediction mode, using at least one of an angular mode, a planar mode, or a DC mode of the neighboring subblock to obtain the second prediction signal.
